(19) United States
(12) Patent Application Publication
(10) Pub. No.: US 2025/0324342 A1
(43) Pub. Date: Oct. 16, 2025

(54) Radio Access Nodes and Methods for Setting Up a Connection in a Wireless Communications Network

(71) Applicant: Telefonaktiebolaget LM Ericsson (publ), Stockholm (SE)

(72) Inventors: Ritesh Shreevastav, Upplands Väsby (SE); Gautham Nayak Seetanadi, Stockholm (SE); Filip Barac, Huddinge (SE); Marco Belleschi, Solna (SE)

(21) Appl. No.: 18/713,276

(22) PCT Filed: Dec. 14, 2022
(86) PCT No.: PCT/SE2022/051174

§ 371 Date: May 24, 2024

Related U.S. Application Data
(60) Provisional application No. 63/265,580, filed on Dec. 17, 2021.

(51) Int. Cl. H04W 36/36; H04W 36/00; H04W 76/27

(52) U.S. Cl. CPC H04W 36/362; H04W 36/0055; H04W 76/27

(57) ABSTRACT

A method, performed by a donor radio access node, for assisting in inter-donor-CU handovers and setting up a connection between a mobile radio access node and a target serving donor radio access node in a wireless communications network. The method comprises transmitting (701) one or more conditional configurations for the connection to the mobile radio access node. A respective conditional configuration of the one or more conditional configurations comprises a conditional configuration command for the connection which conditional configuration command is to be applied when a condition for applying the conditional configuration command is satisfied.

### TECHNICAL FIELD

The embodiments herein relate to radio access nodes and methods for setting up a connection between a mobile radio access node and a target serving donor radio access node in a wireless communications network. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas. Each service area or cell area may provide radio coverage via a beam or a beam group. Each service area or cell area is typically served by a radio access node such as a radio access node e.g., a Wi-Fi access point or a radio base station (RBS), which in some networks may also be denoted, for example, a NodeB, eNodeB (eNB), or gNB as denoted in 5G. A service area or cel area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of the radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

NR uses Orthogonal Frequency Division Multiplexing (OFDM) with configurable bandwidths and subcarrier spacing to efficiently support a diverse set of use-cases and deployment scenarios. With respect to LTE, NR improves deployment flexibility, user throughputs, latency, and reliability. The throughput performance gains are enabled, in part, by enhanced support for Multi-User Multiple-Input Multiple-Output (MU-MIMO) transmission strategies, where two or more UEs receives data on the same time frequency resources, i.e., by spatially separated transmissions.

### Integrated Access and Backhaul (IAB) Overview

Fifth Generation (5G) networks are being designed and deployed considering a dense deployment of small cells in order to simultaneously serve more User Equipment (UEs) with higher throughput and lower delay. However, building from scratch a completely new infrastructure is costly and takes time. Deploying a wireless backhaul is then envisioned to be an economically and technically viable approach to enable flexible and dense networks.

This solution was standardized in 3GPP release 16, under the term Integrated Access and Backhaul (IAB), to support wireless relaying in NG-RAN and has continued in release 17.

### Iab Architecture

IAB is based on a logical split of the access nodes, such as base stations, in a centralized unit (CU) and a distributed unit (DU). The CU-DU split was standardized in 3gpp release 15.

The CU is in charge of the radio resource control (RRC) and the packet data convergence (PCDP) protocol, whereas the DU is in charge of the radio link control (RLC) and medium access control (MAC). An F1 interface connects the CU and the DU. The CU-DU split facilitates separate physical CU and DU, while also allowing a single CU to be connected to multiple DUs.

FIG. 2a shows the basic architecture of IAB. FIG. 2a illustrates a single IAB donor connected to a core network. The IAB donor serves three direct IAB child nodes through two collocated DUs at the donor for wireless backhauling. The center IAB child node in turn serves two IAB nodes through wireless backhaul. All IAB nodes in FIG. 2a backhauls traffic both related to UEs connected to it, and other backhaul traffic from downstream IAB nodes.

Some main components of the IAB architecture are:
1) IAB Node: A node that allows wireless access to the UEs while also backhauling the traffic to other nodes. The IAB node consists of a DU that provides access to connected UEs. The node also consists of a mobile termination (MT) that connects to other IAB nodes or donors in the uplink direction for backhaul.
2) IAB Donor: A node that provides UEs an interface to the core network and wireless functionality to other IAB-nodes to backhaul their traffic to the core network.

FIG. 2b illustrates the basic architecture of IAB and internal split of the nodes. In FIG. 2b the IAB-donor gNB is split into IAB-donor-CU and IAB-donor-DU.

The IAB-nodes may be split into IAB-UE, corresponding to the IAB-MT, and gNB-DU, corresponding to IAB-DU described above. The donor CU is connected to the downstream gNB-DUs via the F1 connection.

The defining feature of IAB is the use of wireless spectrum for both access of UEs and backhauling of data through IAB donors. Thus, there may need to be clear separation of access and backhaul resources to avoid interference between them. This separation of access and backhaul resources is usually not possible to handle during network planning due to the dynamic nature of IAB.

In 3gpp release 16, IAB was standardized with basic support for multi-hop multi-path backhaul for directed acyclic graph (DAG) topology, no mesh-based topology was supported. Rel 16 also supports QoS prioritization of backhaul traffic and flexible resource usage between access and backhaul. Current discussions in release 17 are on topology enhancements for IAB with partial migration of IAB nodes for Radio Link Failure (RLF) recovery and load balancing.

Refer to the following for further information about already standardized IAB work
Madapatha, Charitha et al. “On Integrated Access and Backhaul Networks: Current Status and Potentials.” IEEE Open Journal of the Communications Society 1 (2020): 1374-1389
3GPP TS 38.300. Section 4.7
3GPP TR 38.874 Study on IAB

In release 18, it is expected that the different RAN groups will work towards enhancing functionality of IAB through:
Focus on mobile-IAB/vehicle mounted relays (VMR) providing 5G coverage enhancement to onboard and surrounding UEs
Smart repeaters that build on LTE-repeaters

The initial use cases for mobile-IAB/VMR are expected to be based on 3GPP TR 22.839.

One of the main use cases of a mobile IAB cell is to serve the UEs which are residing in a vehicle with a vehicle mounted relay; Integrated access backhaul solutions. Other relevant use cases for mobile IABs involves a mobile/nomadic IAB network node mounted on a vehicle that provides extended coverage. This involves scenarios where additional coverage is required during special events like concerts, during disasters. The nomadic IAB node provides access to surrounding UEs while the backhaul traffic from the nomadic IAB node is then transmitted wirelessly either with the help of IAB donors or Non-terrestrial networks (NTN). A nomadic IAB node also reduces or even eliminates signal strength loss due to vehicle penetration for UEs that are present in the vehicles.

Advantages of Mobile IAB are
reducing/eliminating the vehicle penetration loss (specially at high frequency),
reducing/eliminating group handover

### F1 Interface

The F1 interface connects the CU to the DU in the split architecture which is also applicable to the IAB architecture. The F1 interface connects the CU of an IAB donor to an IAB DU in the child IAB nodes. The F1 interface also supports control and user plane separation through F1-C and F1-U interfaces respectively.

This interface holds even during IAB mobility where an IAB node moves and connects to parent/donor IAB nodes. In such a scenario the DU present in the mobile IAB node connects to the CU present in the IAB donor.

The IAB-DU initiates a F1 setup with the IAB-CU with which it has a Transport Network Layer (TNL) connection and the initial F1 setup is described in section 8.5 of 3gpp TS 38.401. Once the F1 setup is completed, the IAB donor CU sends a GNB-CU CONFIGURATION UPDATE to optionally indicate the DU cells to be activated.

IAB nodes (including mobile IAB nodes) may be connected to an IAB donor and subsequently to the core network in a standalone or non-standalone method as described below. The below text is from TS 38.401. A high-level flow chart for Stand Alone (SA)-based IAB integration is shown in FIG. 3a of this disclosure. The IAB integration procedure for Non-Standalone SA (NSA) is shown in FIG. 3b.

### 8.12 IAB-Node Integration Procedure

### 8.12.1 Standalone IAB Integration

Phase 1: IAB-MT setup. In this phase, the IAB-MT of the new IAB-node connects to the network in the same way as a UE, by performing RRC connection setup procedure with IAB-donor-CU, authentication with the core network, IAB-node 2-related context management, IAB-node 2's access traffic-related radio bearer configuration at the RAN side (SRBs and optionally DRBs), and, optionally, OAM connectivity establishment by using the IAB-MT's PDU session. The IAB-node can select the parent node for access based on an over-the-air indication from potential parent node IAB-DU (transmitted in SIB1). To indicate its IAB capability, the IAB-MT includes the IAB-node indication in RRCSetupComplete message, to assist the IAB-donor to select an AMF supporting IAB.
NOTE: The signalling flow for UE initial access procedure as shown in FIGS. 8.1-1/FIG. 8.9.1-1 is used for the setup of the IAB-MT.

Phase 2-1: BackHaul (BH) RLC channel establishment. During the bootstrapping procedure, one default BH RLC channel for non-UP traffic e.g. carrying F1-C traffic/non-F1 traffic to and from the IAB-node 2 in the integration phase, is established. This may require the setup of a new BH RLC channel or modification of an existing BH RLC channel between IAB-node 1 and IAB-donor-DU. The IAB-donor-CU may establish additional (non-default) BH RLC channels. This phase also includes configuring the BAP Address of the IAB-node 2 and default BAP Routing ID for the upstream direction.
NOTE: If the OAM connectivity is supported via backhaul IP layer by implementation, one or more BH RLC channels used for OAM traffic can also be established.

Phase 2-2: Routing update. In this phase, the BAP sublayer is updated to support routing between the new IAB-node 2 and the IAB-donor-DU. For the downstream direction, the IAB-donor-CU initiates F1AP procedure to configure the IAB-donor-DU with the mapping from IP header field(s) to the BAP Routing ID related to IAB-node 2. The routing tables are updated on all ancestor IAB-nodes and on the IAB-donor-DU, with routing entries for the new BAP Routing ID(s). This phase may also include the IP address allocation procedure for IAB-node 2. IAB-node 2 may request one or more IP addresses from the IAB-donor-CU via RRC. The IAB-donor-CU may send the IP address(es) to the IAB-node 2 via RRC. The IAB-donor-CU may obtain the IP address(es) from the IAB-donor-DU via F1-AP or by other means (e.g. OAM, DHCP). IP address allocation procedure may occur at any time after RRC connection has been established.

Phase 3: IAB-DU part setup. In this phase, the IAB-DU of IAB-node 2 is configured via OAM. The IAB-DU of IAB-node 2 initiates the TNL establishment, and F1 setup (as defined in clause 8.5) with the IAB-donor-CU using the allocated IP address(es). The IAB-donor-CU discovers collocation of IAB-MT and IAB-DU from the IAB-node's BAP Address included in the F1 SETUP REQUEST message. After the F1 is set up, the IAB-node 2 can start serving the UEs.
NOTE: The IAB-DU can discover the IAB-donor-CU's IP address in the same manner as a non-IAB gNB-DU.

### 8.12.2 Nsa IAB Integration Procedure

Phase 1-1. IAB-MT part setup with E-UTRAN. In this phase, the IAB-MT part connects to the LTE network as a UE, by performing RRC connection setup procedure with an eNB, authentication with the EPC, IAB-node's access traffic-related radio bearer configuration at the E-UTRAN side, and optionally, OAM connectivity establishment by using the IAB-MT's PDN connection. The IAB-node can select the IAB-supporting eNB based on an over-the-air indication from eNB (transmitted in SIB1). To indicate its IAB capability, the IAB-MT includes the IAB-node indication in RRCConnectionSetupComplete message, to assist the eNB to select an MME supporting IAB. The eNB then configures the IAB-MT part with an NR measurement configuration in order to perform discovery, measurement and measurement reporting of candidate gNBs. To enable the eNB choose an en-gNB which supports IAB function, the IAB capability of neighbour gNBs can be pre-configured in the eNB (e.g. by OAM).
NOTE: Other ways to enable the eNB know the IAB capability of neighbour gNBs are not precluded.

Phase 1-2. SgNB addition. In this phase, the IAB-MT part connects to the parent node IAB-DU and IAB-donor-CU via the EN-DC SgNB Addition procedure. The procedure defined in section 8.4.1 is reused. The eNB includes “IAB Node Indication” in SGNB ADDITION REQUEST message to inform the IAB-donor-CU that the request is for an IAB-node. In addition, SRB3 can be set up for the IAB-MT, to transmit RRC message between the IAB-MT and the IAB-donor-CU via the NR links directly.

Phase 2-1: BH RLC channel establishment. This phase is the same as Phase 2-1 in the standalone IAB integration procedure (refer to the Phase 2-1 in clause 8.12.1). This step may occur in Phase 1-2.

Phase 2-2: Routing update. This phase is the same as Phase 2-2 in the standalone IAB integration procedure (refer to the Phase 2-2 in clause 8.12.1), except that the IP traffic on the F1-C interface may be transmitted via the MeNB.

Phase 3. IAB-DU part setup. This phase is the same as Phase 3 in the standalone IAB integration procedure (refer to the Phase 3 in clause 8.12.1), except that the IP traffic on the F1-C interface may be transmitted via the MeNB.

The IAB-donor-CU decides to only configure LTE leg, or only to configure NR leg, or to configure both LTE leg and NR leg, to be used for F1-C traffic transfer. The configuration may be performed before IAB-DU part setup. IAB-donor-CU may also change the configuration after IAB-DU part setup. In case the configuration is not performed before IAB-DU part setup, the IAB node uses the NR leg as the default one. When both LTE leg and NR leg are configured, it is up to the implementation to select the leg for F1-C traffic transfer.

F1 SETUP REQUEST and F1 SETUP RESPONSE message IEs are described below.

### 9.2.1.4 F1 Setup Request

This message is sent by the gNB-DU to transfer information associated to an F1-C interface instance.

NOTE: If a TNL association is shared among several F1-C interface instances, several F1 Setup procedures are issued via the same TNL association after that TNL association has become operational.

Direction: gNB-DU to gNB-CU

| | | | IE type | | | |
|---|---|---|---|---|---|---|
| IE/Group | | | and | Semantics | | Assigned |
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| gNB-DU ID | M | | 9.3.1.9 | | YES | reject |
| gNB-DU | O | | PrintableString(SIZE | | YES | ignore |
| Name | | | (1 . . . 150, . . . )) | | | |
| gNB-DU | | 0 . . . 1 | | List of cells | YES | reject |
| Served | | | | configured | | |
| Cells List | | | | in the gNB- | | |
| | | | | DU | | |
| >gNB-DU | | 1 . . . <maxCellingNBDU> | | | EACH | reject |
| Served | | | | | | |
| Cells Item | | | | | | |
| >>Served | M | | 9.3.1.10 | Information | — | |
| Cell | | | | about the | | |
| Information | | | | cells | | |
| | | | | configured | | |
| | | | | in the gNB- | | |
| | | | | DU | | |
| >>gNB-DU | O | | 9.3.1.18 | RRC | — | |
| System | | | | container | | |
| Information | | | | with system | | |
| | | | | information | | |
| | | | | owned by | | |
| | | | | gNB-DU | | |
| gNB-DU | M | | RRC | | YES | reject |
| RRC version | | | version | | | |
| | | | 9.3.1.70 | | | |
| Transport | O | | 9.3.2.5 | | YES | ignore |
| Layer | | | | | | |
| Address Info | | | | | | |
| BAP Address | O | | 9.3.1.111 | Indicates a | YES | ignore |
| | | | | BAP | | |
| | | | | address | | |
| | | | | assigned to | | |
| | | | | the IAB- | | |
| | | | | node. | | |
| Extended | O | | 9.3.1.205 | | YES | ignore |
| gNB-DU | | | | | | |
| Name | | | | | | |

| Range bound | Explanation |
|---|---|
| maxCellingNBDU | Maximum no. cells that can be served by |
| | a gNB-DU. Value is 512. |

### 9.2.1.5 F1 Setup Response

This message is sent by the gNB-CU to transfer information associated to an F1-C interface instance.

Direction: gNB-CU to gNB-DU

| | | | IE type | | | |
|---|---|---|---|---|---|---|
| IE/Group | | | and | Semantics | | Assigned |
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| gNB-CU | O | | PrintableString(SIZE | Human | YES | ignore |
| Name | | | (1 . . . 150, . . . )) | readable | | |
| | | | | name of the | | |
| | | | | gNB-CU. | | |
| Cells to be | | 0 . . . 1 | | | YES | reject |
| Activated | | | | | | |
| List | | | | | | |
| >Cells | | 1 . . . <maxCellingNBDU> | | List of cells | EACH | reject |
| to be | | | | to be | | |
| Activated | | | | activated | | |
| List Item | | | | | | |
| >>NR | M | | 9.3.1.12 | | — | |
| CGI | | | | | | |
| >>NR | O | | INTEGER | Physical | — | |
| PCI | | | (0 . . . 1007) | Cell ID | | |
| >>gNB-CU | O | | 9.3.1.42 | RRC | YES | reject |
| System | | | | container | | |
| Information | | | | with system | | |
| | | | | information | | |
| | | | | owned by | | |
| | | | | gNB-CU | | |
| >>Available | O | | 9.3.1.65 | | YES | ignore |
| PLMN | | | | | | |
| List | | | | | | |
| >>Extended | O | | 9.3.1.76 | This is | YES | ignore |
| Available | | | | included if | | |
| PLMN | | | | Available | | |
| List | | | | PLMN List | | |
| | | | | IE is | | |
| | | | | included | | |
| | | | | and if more | | |
| | | | | than 6 | | |
| | | | | Available | | |
| | | | | PLMNs is to | | |
| | | | | be | | |
| | | | | signalled. | | |
| >>IAB | O | | 9.3.1.105 | IAB-related | YES | ignore |
| Info | | | | configuration | | |
| IAB- | | | | sent by | | |
| donor- | | | | the IAB- | | |
| CU | | | | donor-CU. | | |
| >>Available | O | | 9.3.1.163 | Indicates | YES | ignore |
| SNPN | | | | the | | |
| ID | | | | available | | |
| List | | | | SNPN ID | | |
| | | | | list. | | |
| | | | | If this IE is | | |
| | | | | included, | | |
| | | | | the content | | |
| | | | | of the | | |
| | | | | Available | | |
| | | | | PLMN List | | |
| | | | | IE and | | |
| | | | | Extended | | |
| | | | | Available | | |
| | | | | PLMN List | | |
| | | | | IE if present | | |
| | | | | in the Cells | | |
| | | | | to be | | |
| | | | | Activated | | |
| | | | | List Item IE | | |
| | | | | is ignored. | | |
| gNB-CU | M | | RRC | | YES | reject |
| RRC | | | version | | | |
| version | | | 9.3.1.70 | | | |
| Transport | | | 9.3.2.5 | | YES | ignore |
| Layer | | | | | | |
| Address | | | | | | |
| Info | | | | | | |
| Uplink BH | O | | 9.3.1.103 | | YES | reject |
| Non-UP | | | | | | |
| Traffic | | | | | | |
| Mapping | | | | | | |
| BAP | O | | 9.3.1.111 | Indicates a | YES | ignore |
| Address | | | | BAP | | |
| | | | | address | | |
| | | | | assigned to | | |
| | | | | the IAB- | | |
| | | | | donor-DU. | | |
| Extended | O | | 9.3.1.206 | | YES | ignore |
| gNB-CU | | | | | | |
| Name | | | | | | |

| Range bound | Explanation |
|---|---|
| maxCellingNBDU | Maximum no. cells that can be served by |
| | a gNB-DU. Value is 512. |

### 9.2.1.10 Gnb-Cu Configuration Update

This message is sent by the gNB-CU to transfer updated information associated to an F1-C interface instance.

NOTE: If F1-C signalling transport is shared among several F1-C interface instances, this message may transfer updated information associated to several F1-C interface instances.

Direction: gNB-CU to gNB-DU

| | | | IE type | | | |
|---|---|---|---|---|---|---|
| IE/Group | | | and | Semantics | | Assigned |
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| Cells to be | | 0 . . . 1 | | List of cells | YES | reject |
| Activated | | | | to be | | |
| List | | | | activated or | | |
| | | | | modified | | |
| >Cells to | | 1 . . . <maxCellingNBDU> | | | EACH | reject |
| be | | | | | | |
| Activated | | | | | | |
| List | | | | | | |
| Item | | | | | | |
| >> NR | M | | 9.3.1.12 | | — | |
| CGI | | | | | | |
| >> NR | O | | INTEGER | Physical | — | |
| PCI | | | (0 . . . 1007) | Cell ID | | |
| >> | O | | 9.3.1.42 | RRC | YES | reject |
| gNB- | | | | container | | |
| CU | | | | with system | | |
| System | | | | information | | |
| Information | | | | owned by | | |
| | | | | gNB-CU | | |
| >>Available | O | | 9.3.1.65 | | YES | ignore |
| PLMN | | | | | | |
| List | | | | | | |
| >>Extended | O | | 9.3.1.76 | This is | YES | ignore |
| Available | | | | included if | | |
| PLMN | | | | Available | | |
| List | | | | PLMN List | | |
| | | | | IE is | | |
| | | | | included | | |
| | | | | and if more | | |
| | | | | than 6 | | |
| | | | | Available | | |
| | | | | PLMNs is to | | |
| | | | | be | | |
| | | | | signalled. | | |
| >>IAB | O | | 9.3.1.105 | IAB-related | YES | ignore |
| Info | | | | configuration | | |
| IAB- | | | | sent by | | |
| donor- | | | | the IAB- | | |
| CU | | | | donor-CU. | | |
| >>Available | O | | 9.3.1.163 | Indicates | YES | ignore |
| SNPN | | | | the | | |
| ID List | | | | available | | |
| | | | | SNPN ID | | |
| | | | | list. | | |
| | | | | If this IE is | | |
| | | | | included, | | |
| | | | | the content | | |
| | | | | of the | | |
| | | | | Available | | |
| | | | | PLMN List | | |
| | | | | IE and | | |
| | | | | Extended | | |
| | | | | Available | | |
| | | | | PLMN List | | |
| | | | | IE if present | | |
| | | | | in the Cells | | |
| | | | | to be | | |
| | | | | Activated | | |
| | | | | List Item IE | | |
| | | | | is ignored. | | |
| Cells to be | | 0 . . . 1 | | List of cells | YES | reject |
| Deactivated | | | | to be | | |
| List | | | | deactivated | | |
| >Cells to | | 1 . . . <maxCellingNBDU> | | | EACH | reject |
| be | | | | | | |
| Deactivated | | | | | | |
| List | | | | | | |
| Item | | | | | | |
| >> NR | M | | 9.3.1.12 | | — | |
| CGI | | | | | | |
| gNB-CU | | 0 . . . 1 | | | YES | ignore |
| TNL | | | | | | |
| Association | | | | | | |
| To Add | | | | | | |
| List | | | | | | |
| >gNB- | | 1 . . . < maxnoofTNLAssociations> | | | EACH | ignore |
| CU TNL | | | | | | |
| Association | | | | | | |
| To | | | | | | |
| Add Item | | | | | | |
| IEs | | | | | | |
| >>TNL | M | | CP | Transport | — | |
| Association | | | Transport | Layer | | |
| Transport | | | Layer | Address of | | |
| Layer | | | Address | the gNB- | | |
| Information | | | 9.3.2.4 | CU. | | |
| >>TNL | M | | ENUMERATED | Indicates | — | |
| Association | | | (ue, | whether the | | |
| Usage | | | non-ue, | TNL | | |
| | | | both, . . . ) | association | | |
| | | | | is only used | | |
| | | | | for UE- | | |
| | | | | associated | | |
| | | | | signalling, | | |
| | | | | or non-UE- | | |
| | | | | associated | | |
| | | | | signalling, | | |
| | | | | or both. For | | |
| | | | | usage of | | |
| | | | | this IE, refer | | |
| | | | | to TS | | |
| | | | | 38.472 [22]. | | |
| gNB-CU | | 0 . . . 1 | | | YES | ignore |
| TNL | | | | | | |
| Association | | | | | | |
| To | | | | | | |
| Remove | | | | | | |
| List | | | | | | |
| >gNB- | | 1 . . . < maxnoofTNLAssociation> | | | EACH | ignore |
| CU TNL | | | | | | |
| Association | | | | | | |
| To | | | | | | |
| Remove | | | | | | |
| Item IEs | | | | | | |
| >>TNL | M | | CP | Transport | — | |
| Association | | | Transport | Layer | | |
| Transport | | | Layer | Address of | | |
| Layer | | | Address | the gNB- | | |
| Address | | | 9.3.2.4 | CU. | | |
| >>TNL | O | | CP | Transport | YES | reject |
| Association | | | Transport | Layer | | |
| Transport | | | Layer | Address of | | |
| Layer | | | Address | the gNB- | | |
| Address | | | 9.3.2.4 | DU. | | |
| gNB-DU | | | | | | |
| gNB-CU | | 0 . . . 1 | | | YES | ignore |
| TNL | | | | | | |
| Association | | | | | | |
| To | | | | | | |
| Update | | | | | | |
| List | | | | | | |
| >gNB- | | 1 . . . < maxnoofTNLAssociations> | | | EACH | ignore |
| CU TNL | | | | | | |
| Association | | | | | | |
| To | | | | | | |
| Update | | | | | | |
| Item IEs | | | | | | |
| >>TNL | M | | CP | Transport | — | |
| Association | | | Transport | Layer | | |
| Transport | | | Layer | Address of | | |
| Layer | | | Address | the gNB- | | |
| Address | | | 9.3.2.4 | CU. | | |
| >>TNL | O | | ENUMERATED | Indicates | — | |
| Association | | | (ue, | whether the | | |
| Usage | | | non-ue, | TNL | | |
| | | | both, . . . ) | association | | |
| | | | | is only used | | |
| | | | | for UE- | | |
| | | | | associated | | |
| | | | | signalling, | | |
| | | | | or non-UE- | | |
| | | | | associated | | |
| | | | | signalling, | | |
| | | | | or both. For | | |
| | | | | usage of | | |
| | | | | this IE, refer | | |
| | | | | to TS | | |
| | | | | 38.472 [22]. | | |
| Cells to be | | 0 . . . 1 | | List of cells | YES | ignore |
| barred List | | | | to be | | |
| | | | | barred. | | |
| >Cells to | | 1 . . . <maxCellingNBDU> | | | EACH | ignore |
| be | | | | | | |
| barred | | | | | | |
| List Item | | | | | | |
| >>NR | M | | 9.3.1.12 | | — | |
| CGI | | | | | | |
| >>Cell | M | | ENUMERATED | | — | |
| Barred | | | (barred, | | | |
| | | | not- | | | |
| | | | barred, . . . ) | | | |
| >>IAB | O | | ENUMERATED | | — | |
| Barred | | | (barred, | | | |
| | | | not- | | | |
| | | | barred, . . . ) | | | |
| Protected | | 0 . . . 1 | | List of | YES | reject |
| E-UTRA | | | | Protected | | |
| Resources | | | | E-UTRA | | |
| List | | | | Resources. | | |
| >Protected | | 1 . . . <maxCellineNB> | | | EACH | reject |
| E- | | | | | | |
| UTRA | | | | | | |
| Resources | | | | | | |
| List | | | | | | |
| Item | | | | | | |
| >>Spectrum | M | | INTEGER | Indicates | — | |
| Sharing | | | (1 . . . maxCellineNB) | the E-UTRA | | |
| Group | | | | cells | | |
| ID | | | | involved in | | |
| | | | | resource | | |
| | | | | coordination | | |
| | | | | with the NR | | |
| | | | | cells | | |
| | | | | affiliated | | |
| | | | | with the | | |
| | | | | same | | |
| | | | | Spectrum | | |
| | | | | Sharing | | |
| | | | | Group ID. | | |
| >> E- | | 1 | | List of | — | |
| UTRA | | | | applicable | | |
| Cells | | | | E-UTRA | | |
| List | | | | cells. | | |
| >>> | | 1 . . . <maxCellineNB> | | | — | |
| E- | | | | | | |
| UTRA | | | | | | |
| Cells | | | | | | |
| List | | | | | | |
| Item | | | | | | |
| >>>> | M | | BIT | Indicates | — | |
| EUTRA | | | STRING | the E- | | |
| Cell | | | (SIZE(28)) | UTRAN Cell | | |
| ID | | | | Global | | |
| | | | | Identifier as | | |
| | | | | defined in | | |
| | | | | subclause | | |
| | | | | 9.2.14 in TS | | |
| | | | | 36.423 [9]. | | |
| >>>> | M | | 9.3.1.64 | | — | |
| Served | | | | | | |
| E- | | | | | | |
| UTRA | | | | | | |
| Cell | | | | | | |
| Information | | | | | | |
| Neighbour | | 0 . . . 1 | | | YES | ignore |
| Cell | | | | | | |
| Information | | | | | | |
| List | | | | | | |
| >Neighbour | | 1 . . . <maxCellingNBDU> | | | EACH | ignore |
| Cell | | | | | | |
| Information | | | | | | |
| List | | | | | | |
| Item | | | | | | |
| >>NR | M | | 9.3.1.12 | | — | |
| CGI | | | | | | |
| >>Intended | O | | 9.3.1.89 | | — | |
| TDD | | | | | | |
| DL-UL | | | | | | |
| Configuration | | | | | | |
| Transport | O | | 9.3.2.5 | | YES | ignore |
| Layer | | | | | | |
| Address | | | | | | |
| Info | | | | | | |
| Uplink BH | O | | 9.3.1.103 | | YES | reject |
| Non-UP | | | | | | |
| Traffic | | | | | | |
| Mapping | | | | | | |
| BAP | O | | 9.3.1.111 | Indicates a | YES | ignore |
| Address | | | | BAP | | |
| | | | | address | | |
| | | | | assigned to | | |
| | | | | the IAB- | | |
| | | | | donor-DU. | | |

| Range bound | Explanation |
|---|---|
| maxCellingNBDU | Maximum numbers of cells that can be |
| | served by a gNB-DU. Value is 512. |
| maxnoofTNLAssociations | Maximum numbers of TNL Associations |
| | between the gNB-CU and the gNB-DU. |
| | Value is 32. |
| maxCellineNB | Maximum no. cells that can be served |
| | by an eNB. Value is 256. |

### 9.2.1.11 Gnb-Cu Configuration Update Acknowledge

This message is sent by a gNB-DU to a gNB-CU to acknowledge update of information associated to an F1-C interface instance.

NOTE: If F1-C signalling transport is shared among several F1-C interface instance, this message may transfer updated information associated to several F1-C interface instances.

Direction: gNB-DU to gNB-CU

| | | | IE type | | | |
|---|---|---|---|---|---|---|
| IE/Group | | | and | Semantics | | Assigned |
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| Cells Failed | | 0 . . . 1 | | List of cells | YES | reject |
| to be | | | | which are | | |
| Activated | | | | failed to be | | |
| List | | | | activated | | |
| >Cells | | 1 . . . <maxCellingNBDU> | | | EACH | reject |
| Failed to | | | | | | |
| be | | | | | | |
| Activated | | | | | | |
| Item | | | | | | |
| >> NR | M | | 9.3.1.12 | | — | |
| CGI | | | | | | |
| >>Cause | M | | 9.3.1.2 | | — | |
| Criticality | O | | 9.3.1.3 | | YES | ignore |
| Diagnostics | | | | | | |
| gNB-CU | | 0 . . . 1 | | | YES | ignore |
| TNL | | | | | | |
| Association | | | | | | |
| Setup List | | | | | | |
| >gNB-CU | | 1 . . . <maxnoofTNLAssociations> | | | EACH | ignore |
| TNL | | | | | | |
| Association | | | | | | |
| Setup | | | | | | |
| Item IEs | | | | | | |
| >>TNL | M | | CP | Transport | — | |
| Association | | | Transport | Layer | | |
| Transport | | | Layer | Address of | | |
| Layer | | | Address | the gNB-CU | | |
| Address | | | 9.3.2.4 | | | |
| gNB-CU | | 0 . . . 1 | | | YES | ignore |
| TNL | | | | | | |
| Association | | | | | | |
| Failed to | | | | | | |
| Setup List | | | | | | |
| >gNB-CU | | 1 . . . <maxnoofTNLAssociations> | | | EACH | ignore |
| TNL | | | | | | |
| Association | | | | | | |
| Failed | | | | | | |
| To Setup | | | | | | |
| Item IEs | | | | | | |
| >TNL | M | | CP | Transport | — | |
| Association | | | Transport | Layer | | |
| Transport | | | Layer | Address of | | |
| Layer | | | Address | the gNB-CU | | |
| Address | | | 9.3.2.4 | | | |
| >>Cause | M | | 9.3.1.2 | | — | |
| Dedicated | | 0 . . . 1 | | List of UEs | YES | ignore |
| SI Delivery | | | | unable to | | |
| Needed UE | | | | receive | | |
| List | | | | system | | |
| | | | | information | | |
| | | | | from | | |
| | | | | broadcast | | |
| >Dedicated | | 1 . . . <maxnoofUEIDs> | | | EACH | ignore |
| SI | | | | | | |
| Delivery | | | | | | |
| Needed | | | | | | |
| UE List | | | | | | |
| >>gNB- | M | | 9.3.1.4 | | — | — |
| CU UE | | | | | | |
| F1AP ID | | | | | | |
| >>NR | M | | 9.3.1.12 | | — | — |
| CGI | | | | | | |
| Transport | O | | 9.3.2.5 | | YES | ignore |
| Layer | | | | | | |
| Address Info | | | | | | |

| Range bound | Explanation |
|---|---|
| maxCellingNBDU | Maximum no. cells that can be served |
| | by a gNB-DU. Value is 512. |
| maxnoofTNLAssociations | Maximum no. of TNL Associations between |
| | the gNB-CU and the gNB-DU. Value is 32. |
| maxnoofUEIDs | Maximum no. of UEs that can be served |
| | by a gNB-DU. Value is 65536. |

### 9.2.1.7 GNB-DU Configuration Update

This message is sent by the gNB-DU to transfer updated information associated to an F1-C interface instance.

NOTE: If F1-C signalling transport is shared among several F1-C interface instance, this message may transfer updated information associated to several F1-C interface instances.

Direction: gNB-DU->gNB-CU

| | | | IE type | | | |
|---|---|---|---|---|---|---|
| IE/Group | | | and | Semantics | | Assigned |
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| Served | | 0 . . . 1 | | Complete list | YES | reject |
| Cells To | | | | of added | | |
| Add List | | | | cells served | | |
| | | | | by the gNB- | | |
| | | | | DU | | |
| >Served | | 1 . . . <maxCellingNBDU> | | | EACH | reject |
| Cells To | | | | | | |
| Add Item | | | | | | |
| >>Served | M | | 9.3.1.10 | Information | — | |
| Cell | | | | about the | | |
| Information | | | | cells | | |
| | | | | configured in | | |
| | | | | the gNB-DU | | |
| >>gNB-DU | O | | 9.3.1.18 | RRC | — | |
| System | | | | container | | |
| Information | | | | with system | | |
| | | | | information | | |
| | | | | owned by | | |
| | | | | gNB-DU | | |
| Served | | 0 . . . 1 | | Complete list | YES | reject |
| Cells To | | | | of modified | | |
| Modify List | | | | cells served | | |
| | | | | by the gNB- | | |
| | | | | DU | | |
| >Served | | 1 . . . <maxCellingNBDU> | | | EACH | reject |
| Cells To | | | | | | |
| Modify | | | | | | |
| Item | | | | | | |
| >>Old | M | | NR CGI | | — | |
| NR | | | 9.3.1.12 | | | |
| CGI | | | | | | |
| >>Served | M | | 9.3.1.10 | Information | — | |
| Cell | | | | about the | | |
| Information | | | | cells | | |
| | | | | configured in | | |
| | | | | the gNB-DU | | |
| >>gNB-DU | O | | 9.3.1.18 | RRC | — | |
| System | | | | container | | |
| Information | | | | with system | | |
| | | | | information | | |
| | | | | owned by | | |
| | | | | gNB-DU | | |
| Served | | 0 . . . 1 | | Complete list | YES | reject |
| Cells To | | | | of deleted | | |
| Delete List | | | | cells served | | |
| | | | | by the gNB- | | |
| | | | | DU | | |
| >Served | | 1 . . . <maxCellingNBDU> | | | EACH | reject |
| Cells To | | | | | | |
| Delete | | | | | | |
| Item | | | | | | |
| >>Old | M | | NR CGI | | — | |
| NR | | | 9.3.1.12 | | | |
| CGI | | | | | | |
| Cells | | 0 . . . 1 | | Complete list | YES | reject |
| Status List | | | | of active cells | | |
| > Cells | | 0 . . . <maxCellingNBDU> | | | EACH | reject |
| Status | | | | | | |
| Item | | | | | | |
| >> NR | M | | 9.3.1.12 | | — | |
| CGI | | | | | | |
| >>Service | M | | 9.3.1.68 | | — | |
| Status | | | | | | |
| Dedicated | | 0 . . . 1 | | List of UEs | YES | ignore |
| SI Delivery | | | | unable to | | |
| Needed UE | | | | receive | | |
| List | | | | system | | |
| | | | | information | | |
| | | | | from | | |
| | | | | broadcast | | |
| > | | 1 . . . <maxnoofUEIDs> | | | EACH | ignore |
| Dedicated | | | | | | |
| SI | | | | | | |
| Delivery | | | | | | |
| Needed | | | | | | |
| UE Item | | | | | | |
| >>gNB-CU | M | | 9.3.1.4 | | — | |
| UE | | | | | | |
| F1AP | | | | | | |
| ID | | | | | | |
| >>NR | M | | 9.3.1.12 | | — | |
| CGI | | | | | | |
| gNB-DU ID | O | | 9.3.1.9 | | YES | reject |
| gNB-DU | | 0 . . . 1 | | | YES | reject |
| TNL | | | | | | |
| Association | | | | | | |
| To | | | | | | |
| Remove | | | | | | |
| List | | | | | | |
| >gNB- | | 1 . . . <maxnoofTNLAssociation> | | | EACH | reject |
| DU TNL | | | | | | |
| Association | | | | | | |
| To | | | | | | |
| Remove | | | | | | |
| Item IEs | | | | | | |
| >>TNL | M | | CP | Transport | — | — |
| Association | | | Transport | Layer | | |
| Transport | | | Layer | Address of | | |
| Layer | | | Address | the gNB-DU. | | |
| Address | | | 9.3.2.4 | | | |
| >>TNL | O | | CP | Transport | — | — |
| Association | | | Transport | Layer | | |
| Transport | | | Layer | Address of | | |
| Layer | | | Address | the gNB-CU | | |
| Address | | | 9.3.2.4 | | | |
| gNB- | | | | | | |
| CU | | | | | | |
| Transport | O | | 9.3.2.5 | | YES | ignore |
| Layer | | | | | | |
| Address | | | | | | |
| Info | | | | | | |

| Range bound | Explanation |
|---|---|
| maxCellingNBDU | Maximum no. cells that can be served |
| | by a gNB-DU. Value is 512. |
| maxnoofUEIDs | Maximum no. of UEs that can be served |
| | by a gNB-DU. Value is 65536. |
| maxnoofTNLAssociations | Maximum numbers of TNL Associations |
| | between the gNB-CU and the gNB-DU. |
| | Value is 32. |

### 9.2.1.8 GNB-DU Configuration Update Acknowledge

This message is sent by a gNB-CU to a gNB-DU to acknowledge update of information associated to an F1-C interface instance.

NOTE: If F1-C signalling transport is shared among several F1-C interface instances, this message may transfer updated information associated to several F1-C interface instances.

Direction: gNB-CU to gNB-DU

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| Transaction | M | | 9.3.1.23 | | YES | reject |
| ID | | | | | | |
| Cells to | | 0 . . . 1 | | List of cells to | YES | reject |
| be | | | | be activated | | |
| Activated | | | | | | |
| List | | | | | | |
| >Cells | | 1 . . . <maxCellingNBDU> | | | EACH | reject |
| to be | | | | | | |
| Activated | | | | | | |
| List | | | | | | |
| Item | | | | | | |
| >> | M | | 9.3.1.12 | | — | |
| NR | | | | | | |
| CGI | | | | | | |
| >> | O | | INTEGER | Physical Cell | — | |
| NR | | | (0 . . . 1007) | ID | | |
| PCI | | | | | | |
| >> | O | | 9.3.1.42 | RRC container | YES | reject |
| gNB- | | | | with system | | |
| CU | | | | information | | |
| System | | | | owned by | | |
| Information | | | | gNB-CU | | |
| >>Available | O | | 9.3.1.65 | | YES | ignore |
| PLMN | | | | | | |
| List | | | | | | |
| >>Extended | O | | 9.3.1.76 | This is | YES | ignore |
| Available | | | | included if | | |
| PLMN | | | | Available | | |
| List | | | | PLMN List IE | | |
| | | | | is included and | | |
| | | | | if more than 6 | | |
| | | | | Available | | |
| | | | | PLMNs is to | | |
| | | | | be signalled. | | |
| >>IAB | O | | 9.3.1.105 | IAB-related | YES | ignore |
| Info | | | | configuration | | |
| IAB- | | | | sent by the | | |
| donor- | | | | IAB-donor-CU. | | |
| CU | | | | | | |
| >>Available | O | | 9.3.1.163 | Indicates the | YES | ignore |
| SNPN | | | | available | | |
| ID | | | | SNPN ID list. | | |
| List | | | | If this IE is | | |
| | | | | included, the | | |
| | | | | content of the | | |
| | | | | Available | | |
| | | | | PLMN List IE | | |
| | | | | and Extended | | |
| | | | | Available | | |
| | | | | PLMN List IE if | | |
| | | | | present in the | | |
| | | | | Cells to be | | |
| | | | | Activated List | | |
| | | | | Item IE is | | |
| | | | | ignored. | | |
| Criticality | O | | 9.3.1.3 | | YES | ignore |
| Diagnostics | | | | | | |
| Cells to | | | | | | |
| be | | 0 . . . 1 | | List of cells to | YES | reject |
| Deactivated | | | | be deactivated | | |
| List | | | | | | |
| >Cells | | 1 . . . <maxCellingNBDU> | | | EACH | reject |
| to be | | | | | | |
| Deactivated | | | | | | |
| List | | | | | | |
| Item | | | | | | |
| >> | M | | 9.3.1.12 | | — | — |
| NR | | | | | | |
| CGI | | | | | | |
| Transport | O | | 9.3.2.5 | | YES | ignore |
| Layer | | | | | | |
| Address | | | | | | |
| Info | | | | | | |
| Uplink BH | O | | 9.3.1.103 | | YES | reject |
| Non-UP | | | | | | |
| Traffic | | | | | | |
| Mapping | | | | | | |
| BAP | O | | 9.3.1.111 | Indicates a | YES | ignore |
| Address | | | | BAP address | | |
| | | | | assigned to | | |
| | | | | the IAB-donor- | | |
| | | | | DU. | | |

| Range bound | Explanation |
|---|---|
| maxCellingNBDU | Maximum no. cells that can be served by a |
| | gNB-DU. Value is 512. |

In mobile IAB, an IAB node may be mounted onboard a vehicle. When the vehicle moves into a different geographical area that is under the coverage of a different IAB donor-CU, the DU of the mobile IAB may need to change its F1 connection from an old (i.e. source) donor IAB node CU to a new (i.e. target) donor IAB node CU. Removing the old F1 connection with the old donor and then establishing a new one with the new donor in the legacy way (i.e. F1 release followed by F1 setup procedures) may cause a long service interruption, especially for inter-donor-CU migration (where F1 has to be teared down and set up via new CU) as shown in FIG. 4.

Further, even for Intra-CU scenario where the IAB node's F1 connection remains anchored at the same CU, there is a need to perform fast F1 setup via a new path.

### SUMMARY

Thus, there exist problems related to how to change an F1 connection from an old (i.e. source) donor IAB node CU to a new (i.e. target) donor IAB node CU.

An object of embodiments herein may be to obviate some of the problems related to changing F1 connections in wireless communication networks.

Embodiments herein disclose one or more conditional F1 configurations that are provided to a mobile IAB in advance (e.g., before the actual arrival of the mobile IAB node at the target CU), in order to reduce delays when the mobile IAB needs to perform inter-donor-CU handovers and moves its F1 connection from one donor CU to another donor CU.

According to an aspect, the object is achieved by a method, performed by a donor node such as a donor radio access node, for assisting in inter-donor-CU handovers and setting up a connection between a mobile radio access node, such as a mobile IAB DU, and a target serving donor node in a wireless communications network.

The donor node may be a donor IAB node (IAB-donor gNB in case of NR).

The radio access nodes of the wireless communications network may apply a CU-DU split. For example, the donor IAB node may comprise a CU and a DU. Likewise, the mobile radio access node may comprise a CU and a DU.

In particular, the method may be performed by a CU of the donor node, such as a gNB-CU. The connection may be a connection between the DU of the mobile radio access node and the CU of the donor node. For example, the connection may be an F1 connection between gNB-DU of an m-IAB and IAB-donor-CU of an IAB-donor gNB. The donor node that performs the method may be the target serving donor node.

The method comprises:
Transmitting one or more conditional F1 configurations to the mobile radio access node. A respective conditional F1 configuration of the one or more conditional F1 configurations may comprise a condition for applying a conditional F1 configuration command and the conditional F1 configuration command which is to be applied when the condition for applying the conditional F1 configuration command is satisfied.

The method may further comprise receiving a selected conditional F1 configuration of the one or more conditional F1 configurations from the mobile radio access node. The selected conditional F1 configuration may be received in a conditional handover complete message. Thus, the method may further comprise executing a handover and connecting to the mobile radio access node, like a normal F1 handover. The selected conditional F1 configuration may have been selected based on satisfaction of the condition for applying the selected conditional F1 configuration.

According to a second aspect, the object is achieved by a donor node, such as a donor IAB node, or specifically an IAB-donor-CU. The donor node is configured to perform the method according to the first aspect above.

According to a third aspect, the object is achieved by a method, performed by a mobile radio access node, such as a mobile IAB DU, for inter-donor-CU handovers and setting up a connection between the mobile radio access node, such as a mobile IAB DU and a target serving donor node in a wireless communications network, such as a donor IAB node (IAB-donor gNB in case of NR). The radio access nodes of the wireless communications network may apply a CU-DU split. For example, the donor IAB node may comprise a CU and a DU. Likewise, the mobile radio access node may comprise a CU and a DU.

Thus some actions of the method may be performed by the CU (MT) of the mobile IAB and some actions of the method may be performed by the DU of the mobile IAB. This will be described in more detail below. In particular, some actions of the method may be performed by a gNB-DU (or in other words the DU) of an m-IAB. The connection may be a connection between the DU of the mobile radio access node and the CU of the donor node. For example, the connection may be an F1 connection between a gNB-DU of an m-IAB and an IAB-donor-CU of an IAB-donor gNB.

The method comprises receiving one or more conditional F1 configurations from a donor node, such as a target serving donor node.

A respective conditional F1 configuration of the one or more conditional F1 configurations may comprise a condition for applying a conditional F1 configuration command and the conditional F1 configuration command which is to be applied when the condition for applying the conditional F1 configuration command is satisfied.

The method may further comprise selecting a conditional F1 configuration of the one or more conditional F1 configurations.

The selected conditional F1 configuration may have been selected based on satisfaction of the condition for applying the selected conditional F1 configuration.

The method may further comprise selecting a new parent access node. The selected new parent access node may be selected based on cell measurements such as RSRP, RSRQ and similar.

The method may further comprise selecting one of the one or more conditional F1 configurations based upon the selected new parent access node (e.g., parent IAB Node) to which the mobile radio access node is connected.

For example, if the mobile radio access node connects to a cell which is associated to a certain conditional F1 configuration, the mobile radio access node may apply the corresponding F1 conditional configuration. Thus, the condition may be related to connection to a cell associated to a certain conditional F1 configuration.

The method may further comprise establishing an IPsec tunnel to a target donor, the SCTP connection to the target donor and the F1 connection to the target donor based on the (indicated and) selected conditional F1 configuration.

The method may further comprise transmitting an indication of the selected conditional F1 configuration to the target access node.

According to a fourth aspect, the object is achieved by a mobile radio access node, such as a mobile IAB or a UE. The mobile radio access node may be defined by a split architecture and comprise a CU (MT) and a DU.

The mobile radio access node is configured to perform the method according to the third aspect above. Thus, the CU (MT) and the DU may be configured to perform the method according to the third aspect above either in combination or alone. Thus, the CU (MT) and the DU may be configured to perform respective actions of the method.

According to a further aspect, the object is achieved by a computer program comprising instructions, which when executed by a processor, causes the processor to perform actions according to any of the aspects above. The donor node or the mobile radio access node or both may comprise the processor.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

The above aspects enable a reduction in F1 connection setup time. No need to rely upon a slow bootstrapping procedure.

The above aspects enable a reduced delay, no (little) interruption, better QoS experience for the UE, less handover failure probability.

The above aspects enable a reduction of service interruption and avoidance of a signaling storm that may otherwise be caused by reconfiguration on a short notice. Reduction of the probability of handover failure.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 illustrates a simplified wireless communication system,

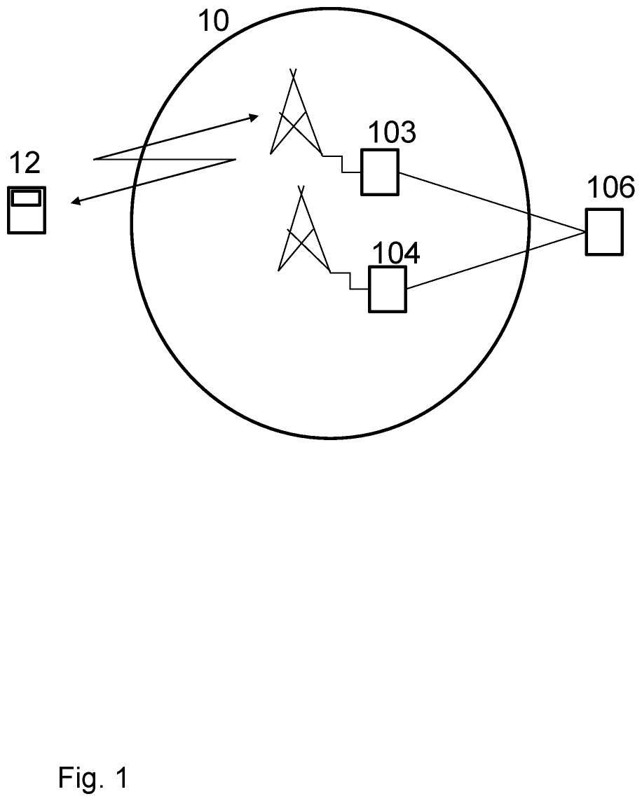

FIG. 2a illustrates a basic architecture of IAB,

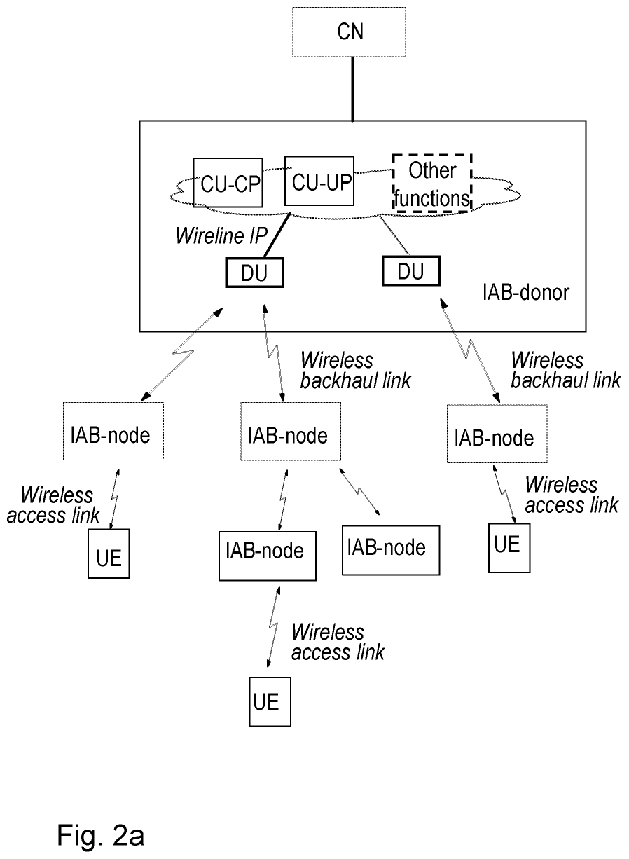

FIG. 2b illustrates a basic architecture of IAB and an internal split of nodes,

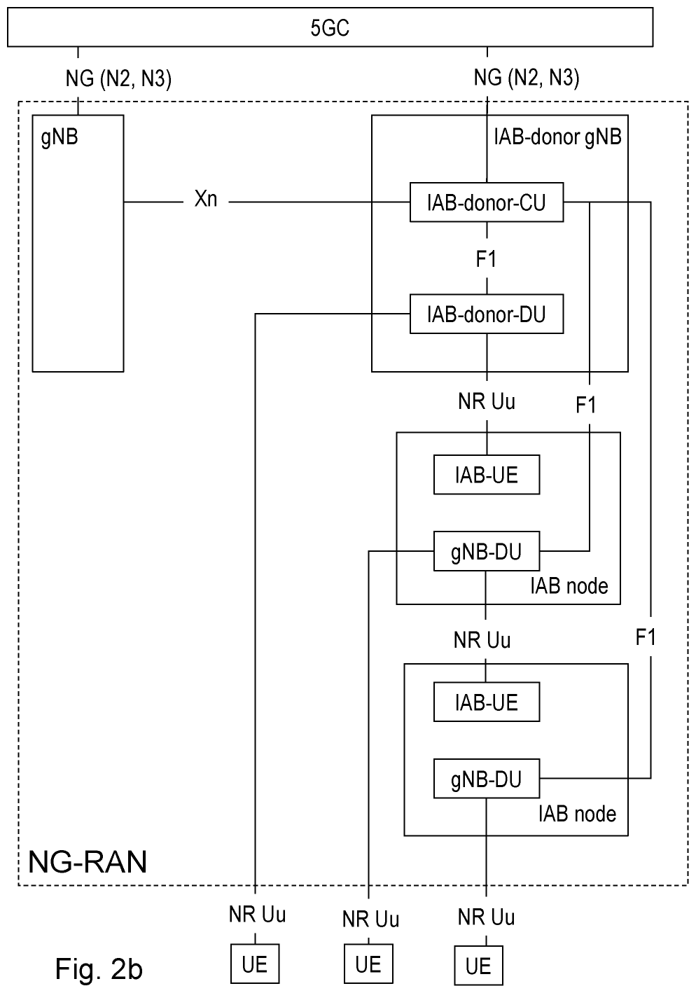

FIG. 3a is a high-level flow chart for Stand Alone (SA)-based IAB integration,

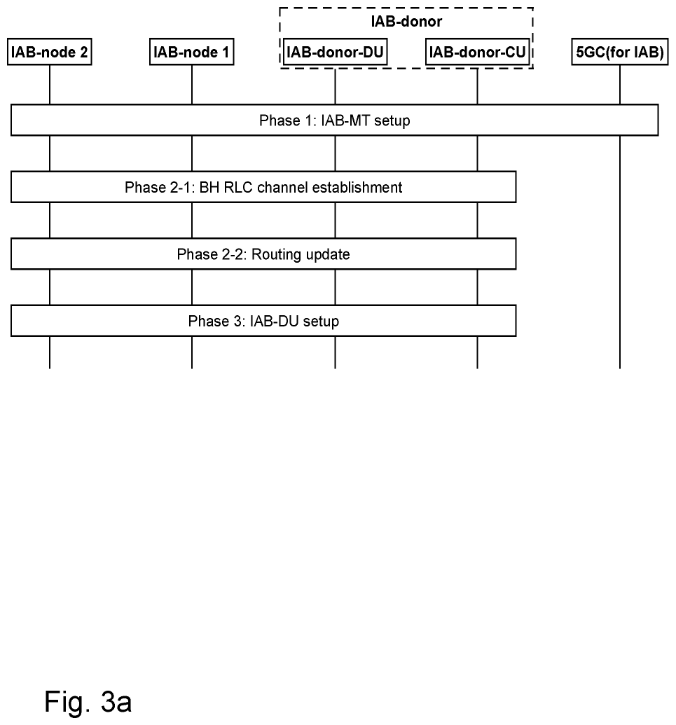

FIG. 3a illustrates an IAB integration procedure for Non-Standalone SA (NSA),

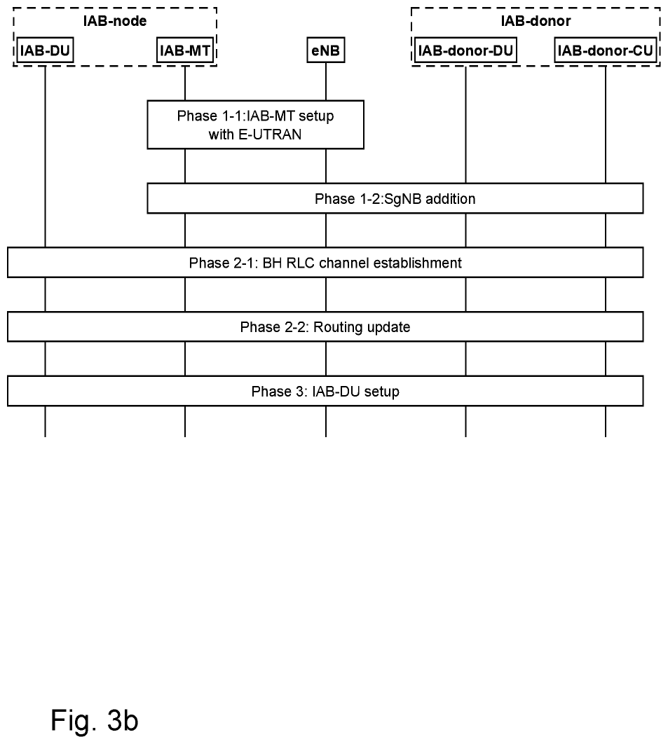

FIG. 4 schematically illustrates inter-donor-CU migration,

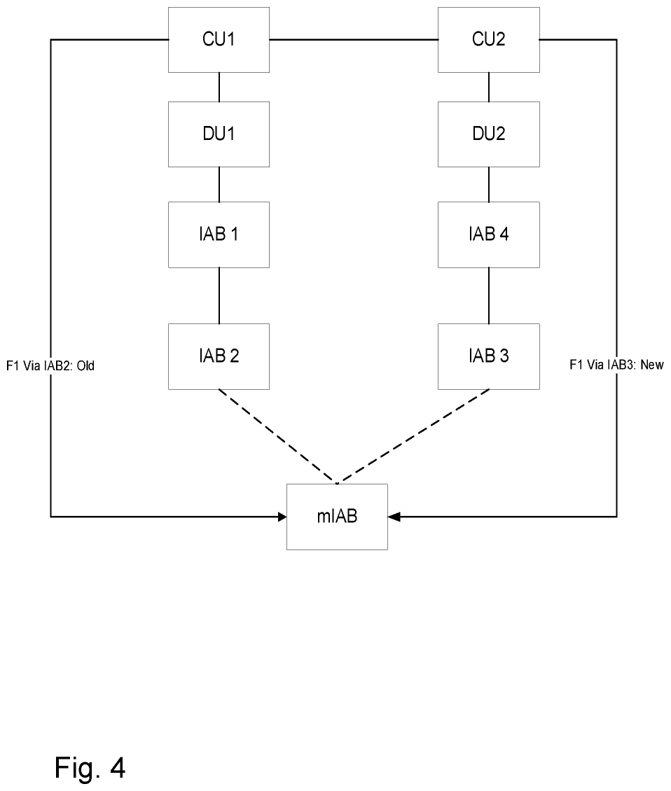

FIG. 5a illustrates a wireless communication system according to embodiments herein,

FIG. 5b is a block diagram schematically illustrating a wireless communications network wherein embodiments herein may be implemented,

FIG. 6 is a signalling diagram describing a method according to embodiments herein,

FIG. 7 is a flow chart describing a method performed by a donor radio access node according to embodiments herein,

FIG. 8 is a flow chart describing a method performed by a mobile radio access node according to embodiments herein,

FIG. 9a is a signalling diagram describing a method according to embodiments herein,

FIG. 9b is a signalling diagram describing a method according to embodiments herein,

FIG. 10 is a block diagram schematically illustrating a donor radio access node according to embodiments herein,

FIG. 11 is a block diagram schematically illustrating a mobile radio access node according to embodiments herein,

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

### DETAILED DESCRIPTION

As mentioned above, there exist problems related to how to change an F1 connection from an old (i.e. source) donor IAB node CU to a new (i.e. target) donor IAB node CU.

An object of embodiments herein may be to obviate some of the problems related to changing F1 connections in wireless communication networks.

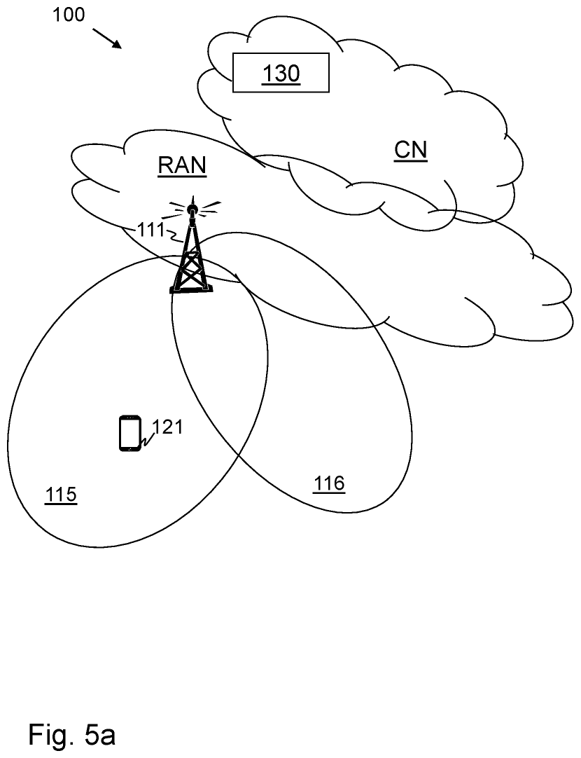

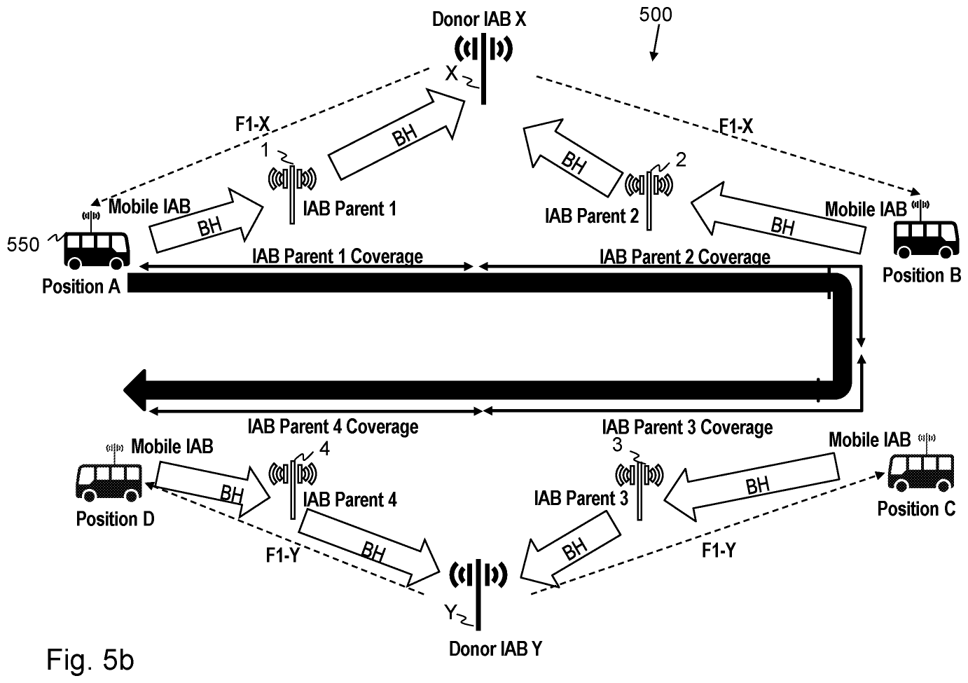

Embodiments herein relate to wireless communication networks in general. FIG. 5a is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Access nodes operate in the wireless communications network 100 such as a radio access node 111. The radio access node 111 provides radio coverage over a geographical area, a service area referred to as a cell 115, which may also be referred to as a beam or a beam group of a first radio access technology (RAT), such as 5G, LTE, Wi-Fi or similar. There may be more than one cell. For example, there may be a second cell 116 as well. The radio access node 111 may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node 111 may be referred to as a serving radio access node and communicates with a UE with Downlink (DL) transmissions to the UE and Uplink (UL) transmissions from the UE.

A number of wireless communications devices operate in the wireless communication network 100, such as a UE 121.

The UE 121 may be a mobile station, a non-access point (non-AP) STA, a STA, a user equipment and/or a wireless terminals, that communicate via one or more Access Networks (AN), e.g. RAN, e.g. via the radio access node 111 to one or more core networks (CN) e.g. comprising a CN node 130, for example comprising an Access Management Function (AMF). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within acell.

In embodiments herein the following definitions apply:
The term “configuration” refers to the parameters needed for an mIAB node to establish an F1 connection towards a donor node, such as a donor radio access node, including the setup of IPsec tunnel (optional) and the SCTP connection that may precede the F1 connection setup. So, the term “configuration” refers to F1 configuration, unless explicitly stated otherwise. In the context of this IvD, the configuration is conditional, meaning that it becomes active once a predefined condition or a set thereof are fulfilled. With the term “F1 configuration” it is referred to a set of parameters provided via F1 signalling to the IAB node, such as (non-limiting examples) the IP addresses, configuration needed to set up SCTP connection configuration to the new donor, the information/configuration for setting up the IPsec tunnel between the mIAB-DU and the new donor, BAP address(es) of the mIAB node, GTP Tunnel IDs, Transport Network Layer addresses of the mIAB node or the new CU, list of cells to be served by the mIAB-DU under new donor together with gNB-DU system information for every cell.
The terms “old donor”, “source donor” and “CU1” are used interchangeably.
The terms “new donor”, “target donor” and “CU2” are used interchangeably.
The abbreviations mIAB, mIAB-MT and mIAB-DU denote a mobile IAB node, its MT and DU, respectively.
The invention is applicable for all scenarios involving F1 migration for both IAB and non-IAB scenarios.
The term “MT conditional configuration” is used to refer to the legacy conditional handover configuration including the reconfiguration with sync for each candidate cell.
A target cell for a handover of an IAB node may be hosted by a parent IAB node or IAB-donor-DU. A parent IAB node may host one or more target cells for this IAB node or IAB-donor-DU.
As cell identified is intended any identifier such as the PCI, or the NCGI or a newly introduced identifier for this or any other purpose.
The terms “candidate configuration” and “conditional configuration” are used interchangeably.

Appropriate methods to handle F1 Setup Procedure for Mobile IAB DU, e.g., to handle a change of F1 connection from an old (i.e. source) donor IAB node CU to a new (i.e. target) donor IAB node CU, are provided below.

Consider that in most use cases a mobile IAB is expected to be mounted on public transport vehicles and to move to a large extent in a pre-determined route. FIG. 5b illustrates a wireless communications network 500 wherein embodiments herein may be implemented and shows a mobile IAB 550 mounted on a bus travelling on a route that is covered by four different parent IAB nodes 1, 2, 3, 4 also denoted IAB Parent 1, 2, 3, 4 in FIG. 5b. The parent IAB nodes 1, 2, 3, 4 will be referred to as the parent access nodes 1, 2, 3, 4 throughout the rest of the document. The parent access nodes 1, 2, 3, 4 backhaul their traffic through two donor nodes X, Y also denoted donor IAB X, donor IAB Y in FIG. 5b.

An IAB node comprises a DU that provides access to UEs around it and an MT that provides a backhaul connection of the IAB node to its parent(s) and the rest of the network. The parent IAB nodes 1, 2, 3, 4 comprises one or more DUs that provide access to UEs and the mobile IAB present in their coverage. The parent IAB nodes also comprises MTs that backhaul its traffic together with traffic from the mobile IAB node. Finally, the two donor nodes X and Y comprise a respective DU that provides access and a respective CU that is connected to the core network. The CUs in both donor nodes maintain an F1 connection to parent access nodes under it.

The mobile IAB node maintains an F1 connection to the donor node (one donor node at a time). In FIG. 5b the mobile IAB 550 connects to the following nodes in the different positions as described below:
1) Position A: BH through parent access node 1, F1 connection to donor node X, referred to as connection F1-X in FIG. 5b
2) Position B: BH through parent access node 2, F1 connection to donor node X
3) Position C: BH through parent access node 3, F1 connection to donor node Y, referred to as connection F1-Y in FIG. 5b
4) Position D: BH through parent access node 4, F1 connection to donor node Y

The mobile IAB may change the F1 connection from donor X to donor Y when moving from position B to C. If the mobile IAB changes the F1 connection from donor X to donor Y this requires an F1 handover from donor X to donor Y.

Given that the routes of public transport vehicles are usually known in advance, this determinism of the route of the mobile IAB node may be exploited by configuring the mobile IAB node with one or more conditional F1 setup configurations, to prepare F1 handovers in advance, e.g., before the actual arrival of the mobile IAB node at the target CU. The (already specified) conditional handover is applicable according to 3GPP specifications to UEs and IAB-MTs.

The (already specified) conditional handover configuration applies to UE/IAB-MT and it may include a “reconfiguration with sync” for the candidate cell. Hence it may comprise a set of radio parameters, as well as MAC/RRC parameters that the UE or the IAB-MT shall apply.

On the other hand, embodiments herein are focused on conditional HO of the F1 connection between the IAB-DU and the donor, thus on the conditional configuration of IAB-DU of the migrating IAB node. For example, the F1 conditional configuration, may include a set of parameters intended for the DU part of the IAB node, such as configuration needed to set up SCTP connection to the new donor, the information/configuration for setting up the IPsec tunnel between the mIAB-DU and the new donor, GTP Tunnel IDs for user plane traffic, Transport Network Layer address(es) of the new CU and of the mobile IAB node, BAP address(es) of the mIAB node, list of cells to be served by the mIAB-DU under new donor together with gNB-DU system information for every cell.

In another variant, if an exact route of the vehicle is unknown in advance, the mobile IAB node may be configured with multiple conditional F1 configurations.

In another variant, if the exact route of the vehicle is known in advance, the mobile IAB node may be configured with multiple conditional F1 configurations, pertaining not only to a next donor, but to a number of subsequent donors to which the mobile IAB (mIAB) node will connect later along the route.

The mobile IAB node (mIAB) 550 of FIG. 5b that is bound to change its serving donor node is provided with a conditional F1 configuration. The conditional F1 configuration is used to establish an F1 connection to the next serving donor CU. The configurations may, for example, be provided to the mIAB while it is still connected to the old donor node.

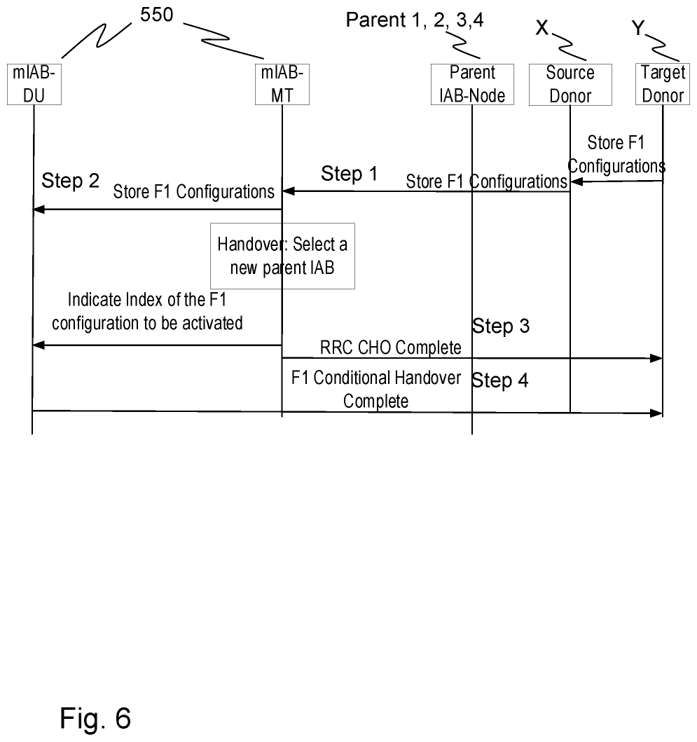

Exemplifying methods according to embodiments herein will now be described with reference to a signaling diagram in FIG. 6 and with continued reference to FIGS. 5a and 5b. The signaling diagram illustrates an interaction between the m-IAB 550, including m-IAB-DU and m-IAB-MT, a parent IAB node and a source donor X, corresponding to the donor IAB X in FIG. 5b, and a target donor Y, corresponding to the donor IAB Y in FIG. 5b.

Step 1: One or more donors provide one or more conditional F1 configurations to the mIAB-MT or to mIAB-DU via RRC or via F1, respectively. The configurations may be provided, e.g., from the target donor to the source donor and then to the mIAB.

Note: mIAB-MT may receive such configurations via RRC from source or target Donor CU. The mIAB-MT may send it to mIAB-DU for storage.

Step 2: mIAB-MT informs mIAB-DU to select one of the conditional F1 configuration based upon the selected new parent IAB Node to which the mIAB-MT connected.

Step 3: The mIAB-MT sends RRC CHO Complete to the target donor.

Step 4: m-IAB-DU sends an F1 CHO Complete message to the target donor. Alternatively, the information of the F1 CHO Complete may also be sent inside the message in step 3. For example, when new F1-related parameters are applied by the mIAB-DU the mIAB-DU may inform the mIAB-MT, e.g., via a proprietary interface, of the applied F1-related parameters, and the mIAB-MT may then convey this information in an RRC message, such as in RRC CHO Complete, and send the RRC message to the target donor node Y, more specifically to the CU of the target donor node Y.

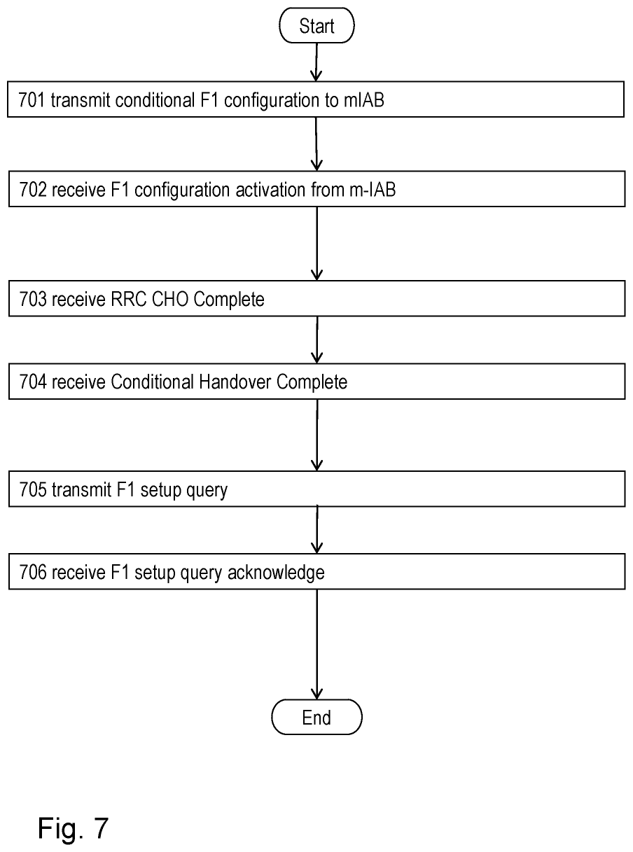

Exemplifying methods according to embodiments herein will now be described with reference to a flow chart in FIG. 7 and with continued reference to FIGS. 5a, 5b and 6. The flow chart illustrates a method, performed by the donor node X, Y, such as the donor IAB, or more specifically the CU of the donor IAB. The donor IAB may be an IAB-donor gNB. Then the CU of the donor IAB may be an IAB-donor-CU. The donor node may be the target donor node Y of FIG. 5b. However, in general the donor radio access node X, Y that performs the method may be the target serving donor radio access node Y or the source radio access node X. The method is for assisting in inter-donor-CU handovers and setting up a connection F1-Y between the mobile radio access node 550, such as a mobile IAB DU, and the target serving donor node Y in the wireless communications network 500.

Thus, in some embodiments herein the donor radio access node X, Y is a donor IAB node, such as an IAB-donor gNB, and the mobile radio access node 550 is a mobile IAB node.

The radio access nodes 550, X, Y of the wireless communications network 500 may apply a Central Unit-Distributed Unit, CU-DU, split. Then the method may be performed by the CU of the donor radio access node X, Y. Further, then the connection F1-Y between the mobile radio access node 550 and the target serving donor radio access node Y may be the connection between the DU of the mobile radio access node 550 and the CU of the target donor radio access node Y.

For example, the donor IAB node may comprise a CU and a DU. Likewise, the mobile radio access node may comprise a CU and a DU.

In particular, the method may be performed by a CU of the donor radio access node X, Y, such as a gNB-CU.

There may also be a connection F1-X between the mobile radio access node 550 and the source serving donor radio access node X. This connection may be a connection between the DU of the mobile radio access node 550 and the CU of the source donor radio access node X.

Specifically, the wireless communications network 500 may be a New Radio, NR, network. Then the mobile radio access node 550 is an m-IAB node, the target serving donor radio access node Y is an IAB-donor gNB and the connection F1-Y between the mobile radio access node 550 and the target serving donor radio access node Y is an F1 connection between the gNB-DU of the m-IAB and the IAB-donor-CU of the target serving IAB-donor gNB Y.

### Action 701

The donor node X, Y transmits one or more conditional configurations for the connection F1-Y between the mobile radio access node 550 and the target serving donor radio access node Y to the mobile radio access node 550.

A respective conditional configuration of the one or more conditional configurations comprises a conditional configuration command for the connection F1-Y which conditional configuration command is to be applied when a condition for applying the conditional configuration command is satisfied.

The respective conditional configuration of the one or more conditional configurations may further comprise a condition for applying the conditional configuration command.

In some embodiments the conditional configuration for the connection F1-Y between the mobile radio access node 550 and the target serving donor radio access node Y comprises information necessary for the mobile radio access node 550 to set up the connection F1-Y to the target serving donor radio access node Y.

The information necessary for the mobile radio access node 550 to set up the connection F1-Y to the target serving donor radio access node Y may comprise one or more of:
Transport Network Layer, TNL, or Internet Protocol, IP, addresses, or both, of the target serving donor radio access node Y;
configuration needed to set up a Stream Control Transmission Protocol, SCTP, connection to the target serving donor radio access node Y;
configuration for setting up a secure IP tunnel between the mobile radio access node 550 and the target serving donor radio access node Y;
a Tunnelling Protocol, TP, Tunnel Endpoint Identifier, TEID, of TP tunnels to be used for user plane traffic;
a list of cells to be served by a distributed unit mIAB-DU of the mobile radio access node 550 under the target serving donor radio access node Y together with system information for every cell comprised in the list of cells, the system information is owned by the distributed unit mIAB-DU of the mobile radio access node 550; and
Backhaul Adaptation Protocol, BAP, addresses of the mobile radio access node 550.

In some embodiments transmitting the one or more conditional configurations to the mobile radio access node 550 is performed via Radio Resource Control, RRC, signaling or via signaling on a connection F1-X between the mobile radio access node 550 and the source serving donor radio access node X, respectively.

For example the one or more conditional configurations may be transmitted to the mobile radio access node 550 via RRC signaling in an RRCReconfiguration message. In one variant, an F1 conditional configuration(s) is(are) delivered to the mIAB-MT of the mIAB node 550 via RRC from the old donor, for example, together with an “MT conditional handover configuration”, e.g., in the same conditionalReconfiguration IE and in an F1 conditional reconfiguration list including F1 configuration for each candidate target parent access node 1, 2, 3, 4. The Conditional HandOver (CHO) configuration may be delivered to the UE via RRC signalling while the UE is connected to a certain cell. The CHO configuration provided by the gNB may imply a RRCReconfiguration message containing a reconfiguration with sync (reconfigurationWithSync) for each candidate cell towards which the UE may perform the conditional handover.

The RRCReconfiguration message may comprise an Information Element, IE, for conditional Reconfiguration which comprises the one or more conditional configurations for the connection F1-Y between the mobile radio access node 550 and the target serving donor radio access node Y.

In some embodiments the IE for conditional Reconfiguration comprises a conditional reconfiguration list for the connection F1-Y between the mobile radio access node 550 and the target serving donor radio access node Y including configuration of the connection F1-Y for each candidate target parent access node 1, 2, 3, 4.

When the connection F1-Y between the mobile radio access node 550 and the target serving donor radio access node Y is an F1 connection then the conditional configuration may be a conditional F1 configuration. Then, as a first action 701 of FIG. 7 the donor node X, Y, such as the target donor node Y, transmits one or more conditional F1 configurations to the mobile radio access node 550.

A respective conditional F1 configuration of the one or more conditional F1 configurations may further comprise a condition for applying a conditional F1 configuration command and the conditional F1 configuration command which is to be applied when the condition for applying the conditional F1 configuration command is satisfied.

In some embodiments the conditional F1 configuration comprises information necessary for the mIAB-DU to set up F1 to the new donor node.

Such information may be the TNL/IP addresses of the new donor (e.g., separate addresses for F1-C, F1-U and non-F1 traffic), configuration needed to set up SCTP connection to the new donor, the information/configuration for setting up the IPsec tunnel between the mIAB-DU and the new donor, GTP TEIDs of the GTP-U tunnels to be used for user plane traffic, list of cells to be served by the mIAB-DU under new donor together with gNB-DU system information for every cell, BAP address(es) of the mIAB node, the etc.

Action 701 corresponds to Step 1 in FIG. 6.

### Action 702

The donor node X, Y may receive a configuration activation for the connection F1-Y between the mobile radio access node 550 and the target serving donor radio access node Y from the mobile radio access node 550 in response to the transmitted one or more conditional configurations.

Thus, in action 702 the donor node X, Y, such as the target donor node Y, may receive an F1 configuration activation from the m-IAB in response to the transmitted one or more conditional F1 configurations.

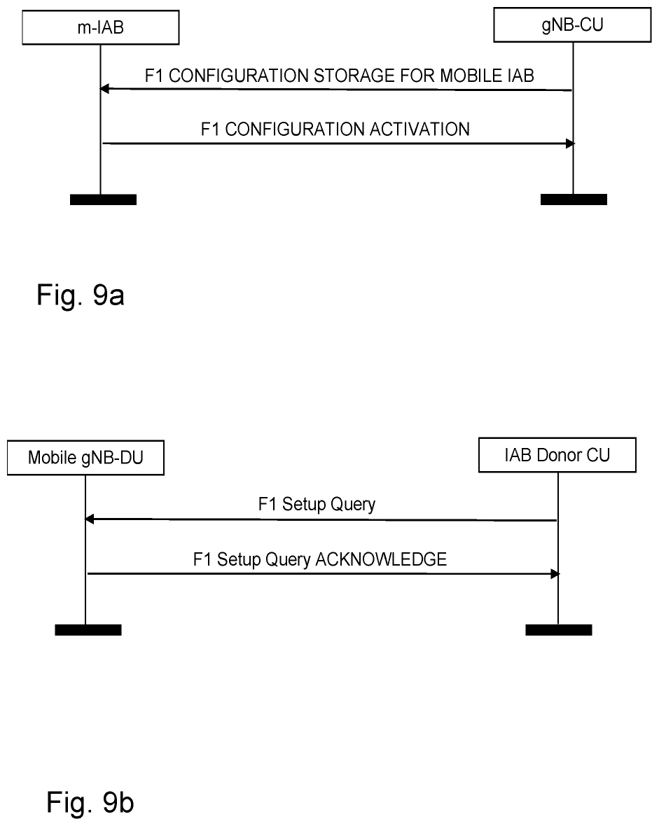

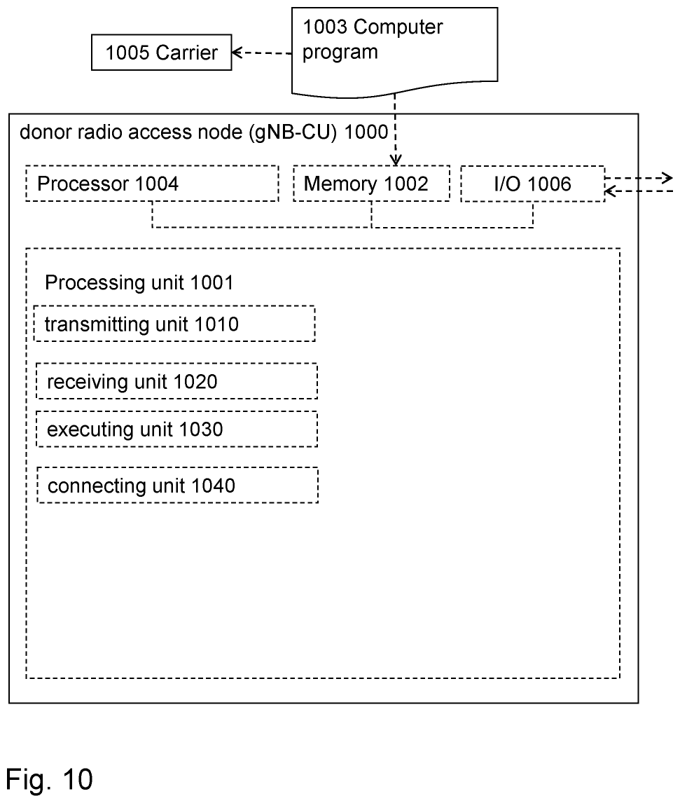

F1 configuration activation is further described in relation to FIG. 9a below.

### Action 703

In action 703 the target donor node Y may receive a selected conditional configuration of the one or more conditional configurations from the mobile radio access node 550, specifically from the MT-part, such as the m-IAB-MT. For example, when new F1-related parameters are applied by the DU-part of the mobile radio access node 550 then the DU-part may inform the MT-part, e.g., via a proprietary interface, of the applied F1-related parameters, and the MT-part may then convey this information in an RRC message and send it to the target donor node Y, more specifically to the CU of the target donor node Y.

For example, in action 703 the target donor node Y may receive a selected conditional F1 configuration of the one or more conditional F1 configurations from the mobile radio access node 550. The selected conditional F1 configuration may be received in a conditional handover complete message, such as in an RRC CHO Complete message. Thus, the method may further comprise executing a handover and connecting to the mobile radio access node 550, like a normal F1 handover. The selected conditional F1 configuration may have been selected based on satisfaction of the condition for applying the selected conditional F1 configuration.

In some embodiments, in action 703 the target donor node Y receives RRC CHO Complete from the mobile radio access node 550, specifically from the MT-part, such as the m-IAB-MT. The RRC CHO Complete may comprise information about the F1 conditional handover as described above in relation to FIG. 6.

Action 703 corresponds to Step 3 in FIG. 6.

### Action 704

In action 704 the target donor node Y may receive a message from the mobile radio access node 550, specifically from the DU-part, such as from the m-IAB-DU, that informs the target donor node Y that the connection between the mobile radio access node 550 and the target donor node Y has been set up. The received message may comprise information about the conditional handover of the connection between the mobile radio access node 550 and the target donor node Y. The message sent in action 704 may be sent over the connection between the mobile radio access node 550 and the target donor node Y. For example, the m-IAB-DU may send the message over the F1 connection to the target donor node Y.

For example, in action 704 the target donor node Y may receive an F1 CHO Complete message from the mobile radio access node 550, specifically from the DU-part, such as the m-IAB-DU. The F1 CHO Complete message informs the target donor node Y (e.g., the CU part) that the connection between the mobile radio access node 550 and the target donor node Y has been set up. The F1 CHO Complete message may comprise information about the F1 conditional handover. Thus, the m-IAB-DU may send the F1 CHO Complete message over the F1 connection to the target donor node Y.

Action 704 corresponds to Step 4 in FIG. 6.

Thus in actions 703 and 704 the target donor node Y may receive information related to the selected conditional F1 configuration of the one or more conditional F1 configurations from the mobile radio access node 550. For example, the target donor node Y may receive an indication of the selected conditional F1 configuration.

As mentioned above, the selected conditional F1 configuration may be received in a conditional handover complete message. Thus, the method may further comprise executing a handover and connecting to the mobile radio access node 550, like a normal F1 handover. The selected conditional F1 configuration may have been selected based on satisfaction of the condition for applying the selected conditional F1 configuration.

In action 705 the target donor node Y may transmit an F1 setup query message to the mobile radio access node 550, such as the m-IAB 550. F1 setup query is further described in relation to FIG. 9b below.

In action 706 the target donor node Y may receive an F1 setup query acknowledge message in response to the transmitted F1 setup query message.

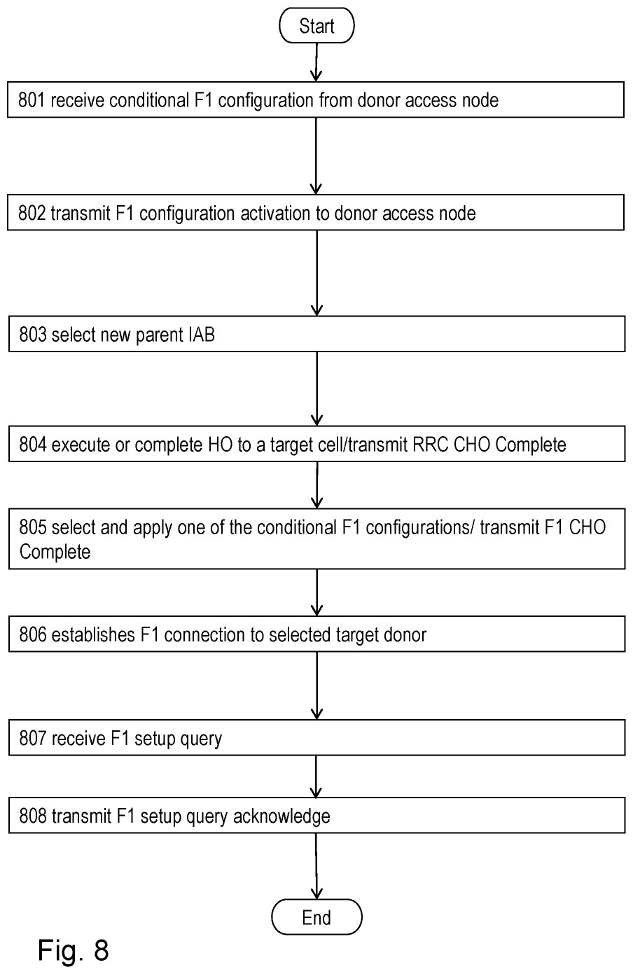

Exemplifying methods according to embodiments herein will now be described with reference to a flow chart in FIG. 8 and with continued reference to FIGS. 5a, 5b and 6. The flow chart illustrates a method, performed by the mobile radio access node 550, such as the m-IAB.

The method is for performing inter-donor-CU handovers and setting up a connection F1-Y between the mobile radio access node 550, such as a mobile IAB DU, and a target serving donor node Y in the wireless communications network 500. The method may be applicable to UEs as well.

The method actions may be performed in any suitable order. Some method actions may be optional.

### Action 801

The mobile radio access node 550 receives, from a donor radio access node X, Y, the one or more conditional configurations for the connection F1-Y between the mobile radio access node 550 and the target serving donor radio access node Y. The respective conditional configuration of the one or more conditional configurations comprises the conditional configuration command which is to be applied when the condition for applying the conditional configuration command is satisfied.

Thus, in action 801 the mobile radio access node 550 receives one or more conditional F1 configurations from a donor node, such as a target serving donor node Y.

A respective conditional F1 configuration of the one or more conditional F1 configurations may comprise a condition for applying a conditional F1 configuration command and the conditional F1 configuration command which is to be applied when the condition for applying the conditional F1 configuration command is satisfied.

Receiving the one or more conditional configurations for the connection F1-Y may be performed via RRC by a Central Unit of the mobile radio access node 550 or via a connection F1-X between the mobile radio access node 550 and the source serving donor radio access node X by a distributed unit mIAB-DU of the mobile radio access node 550.

In some embodiments disclosed herein the mobile radio access node 550 receives the one or more conditional configurations via RRC signaling, e.g., in an RRCReconfiguration message.

The RRCReconfiguration message may comprise an Information Element, IE, for conditional Reconfiguration which comprises the one or more conditional configurations.

In some embodiments disclosed herein the IE for conditional Reconfiguration comprises a conditional reconfiguration list for the connection F1-Y including configuration of the connection F1-Y for each candidate target parent access node (1, 2, 3, 4).

### Action 802

The mobile radio access node 550 may transmit a configuration activation for the connection F1-Y between the mobile radio access node 550 and the target serving donor radio access node Y in response to the received one or more conditional configurations.

Thus, in action 802 the mobile radio access node 550 may respond to the one or more conditional F1 configurations received in action 801 from the donor node X, Y by transmitting an F1 configuration activation to the donor node X, Y.

### Action 803

In some embodiments the mobile radio access node 550 selects a new parent access node 1, 2, 3, 4. Then selecting the conditional configuration of the one or more conditional configurations may be based on the selected new parent access node 1, 2, 3, 4. In other words, selecting the conditional configuration of the one or more conditional configurations may be based on which new parent access node 1, 2, 3, 4 has been selected from candidates of new parent access nodes 1, 2, 3, 4. The selected new parent access node 1, 2, 3, 4 may be selected based on cell measurements such as RSRP, RSRQ and similar. For example, the mobile radio access node (MT of the mobile radio access node) 550 acts like a UE and connects to a cell. The CU of the donor node X, Y may provide the F1 CHO config based upon the cell to which the MT of the mobile radio access node 550 connects. If the MT of the mobile radio access node 550 connects to a certain cell, such as cell 115, it may determine if there is a F1 CHO matching cell 115. If yes, it may apply that F1 CHO.

### Action 804

In action 804 the mobile radio access node 550 may execute or complete a HO to a target cell. For example, the mobile radio access node may execute or complete a CHO to a target cell (i.e. send RRCReconfigurationComplete). In another embodiment the mIAB-MT receives an RRC message including a reconfiguration with sync for ordinary (non-CHO) handover to a target cell.

### Action 805

The mobile radio access node 550 selects a conditional configuration of the one or more conditional configurations based on satisfaction of the condition for applying the selected conditional configuration.

For example, in action 805 the mobile radio access node 550 may select a conditional F1 configuration of the one or more conditional F1 configurations.

The selected conditional F1 configuration may have been selected based on satisfaction of the condition for applying the selected conditional F1 configuration.

For example, the mobile radio access node 550 may select one of the one or more conditional F1 configurations based upon the selected new parent access node (e.g., parent IAB Node) to which the mobile radio access node 550 is connected.

For example, if the mobile radio access node 550 connects to a cell which is associated to a certain conditional F1 configuration, the mobile radio access node 550 may apply the corresponding F1 conditional configuration. Thus, the condition may be related to connection to a cell associated to a certain conditional F1 configuration.

Further, a trigger for applying a particular configuration may be, e.g., that the mIAB-MT executes or completes a CHO to a target cell (i.e., send RRCReconfigurationComplete), or the mIAB-MT receives an RRC message including an reconfiguration with sync for ordinary (non-CHO) handover to a target cell.

In a detailed embodiment the mIAB-MT may conclude from the target cell identifier the corresponding F1 configuration. The IAB-MT part of the IAB node is provided for each target cell an indication of whether or not for that candidate target cell the IAB node should apply an F1 conditional reconfiguration. If the target cell is one of the cells for which F1 conditional reconfiguration should be applied, the mIAB-MT may inform the mIAB-DU by indicating the cell to which the handover was executed/completed. The mIAB-DU may then apply a corresponding F1 configuration for this cell. If the target cell is not one of the cells for which F1 conditional reconfiguration should be applied, the mIAB-MT may refrain from signal anything to the mIAB-DU, so that the mIAB-DU keeps the current F1 configuration.

Thus in action 805 the mobile radio access node 550 may transmit information related to the selected conditional F1 configuration of the one or more conditional F1 configurations to the target donor node Y. For example, the mobile radio access node 550 may transmit an indication of the selected conditional F1.

As mentioned above, the selected conditional F1 configuration may be transmitted in a conditional handover complete message. Thus, the method may further comprise executing a handover and connecting to the target donor node Y, like a normal F1 handover. The selected conditional F1 configuration may have been selected based on satisfaction of the condition for applying the selected conditional F1 configuration.

### Action 806

The mobile radio access node 550 establishes the connection F1-Y to the target serving donor radio access node Y based on the selected conditional configuration.

The mobile radio access node 550 may further establish any one or more of: a secure IP tunnel to the target serving donor radio access node Y, and a Stream Control Transmission Protocol, SCTP, connection to the target serving donor radio access node Y based on the selected conditional configuration.

Thus, in action 806 the mobile radio access node 550 may establish an IPsec tunnel to the target donor Y, an SCTP connection to the target donor Y and the F1 connection to the target donor Y based on the (indicated and) selected conditional F1 configuration.

### Action 807

In action 807 the mobile radio access node 550 may receive a connection set up query for the connection F1-Y to the target serving donor radio access node Y, such as an F1 setup query, from the target donor Y. This will be described further below.

### Action 808

In action 808 the mobile radio access node 550 may transmit a connection set up query acknowledge, such as an F1 setup query acknowledge, to the target donor Y in response to the received connection set up query, such as the F1 setup query, from the target donor Y in action 807.

### DETAILED EMBODIMENTS

As mentioned above embodiments herein disclose methods for inter-donor-CU handovers and setting up the connection F1-Y between the mobile radio access node 550 and the target serving donor node Y in the wireless communications network 500, such as the F1 connection. In the detailed embodiments below the connection F1-Y between the mobile radio access node 550 and the target serving donor node Y will be exemplified with an F1 connection.

1. As mentioned above, the mobile IAB node (mIAB) 550 of FIG. 5b that is bound to change its serving donor is provided with a conditional F1 configuration. The conditional F1 configuration is used to establish an F1 connection to the next serving donor CU. The configurations may, for example, be provided to the mIAB while it is still connected to the old donor, such as the donor X.
i. In one variant, the mIAB 550 is provided with multiple candidate conditional F1 configurations.
ii. In one variant, each conditional F1 configuration is associated with an identifier used to distinguish between the different configurations. For example, each F1 conditional configuration may be associated to a list of one or more target cell identifiers pertaining to a candidate target parent IAB-DU 1, 2, 3, 4, wherein a cell identifier may be the cell identity or the cell global identifier (CGI) of a cell, or a newly introduced identifier. For example, the configuration may be such that all the cells associated to the same F1 conditional configuration are controlled by the same parent IAB node. If the mIAB 550 connects to a cell which is associated to a certain conditional F1 configuration, the mIAB node 550 applies the corresponding F1 conditional configuration.
In another variant of this embodiment the F1 configuration is associated to the gNB-DU ID of the parent access node 1, 2, 3, 4 hosting the target cell to which the mIAB node is being handed-over. If the mIAB 550 connects to such parent access node 1, 2, 3, 4, e.g. to a cell hosted by such parent access node 1, 2, 3, 4, the F1 configuration corresponding to such gNB-DU is applied.
iii. In one variant, the F1 conditional configuration(s) is(are) delivered to the mIAB-MT of the mIAB node 550 via RRC from the old donor, for example, together with the “MT conditional handover configuration”, e.g., in the same conditionalReconfiguration IE and in a F1 conditional reconfiguration list including F1 configuration for each candidate target parent access node 1, 2, 3, 4. Alternatively, the F1 conditional configuration(s) may be provided via RRC in a separate RRC message, such as F1ConditionaReconfiguration.) Herein, either an existing RRC or a newly defined RRC procedure may be used.
iv. In another variant, the F1 conditional configuration(s) are provided to the mIAB-DU of the mIAB node 550 by the old donor via F1AP (and stored in the mIAB-DU). Herein, either and existing F1 or a newly defined F1 procedure may be used.
v. In another variant, the configurations are provided to the mIAB node 550 by an Operations, Administration and Maintenance (OAM) system, e.g., via an OAM connection that it maintains, e.g. via Data Radio Bearers established by the mIAB-MT or via the backhaul IP connection (as defined in TS 38.401). In another, also OAM-related variant, the configurations may be preconfigured.
vi. In another variant, the F1 conditional configuration(s) are provided to the mIAB-DU of the mIAB node 550 by the old donor via F1AP (and stored in the mIAB-DU) as in the previous method. Additionally, the mIAB-MT part of the IAB node 550 may be provided for each target cell an indication of whether for that candidate target cell the mIAB node 550 should apply an F1 conditional reconfiguration when a handover towards such candidate target cell is executed or completed. This may be represented by a list of target cells including such indication of whether F1 conditional reconfiguration should be applied or not. In case the mIAB-MT is configured with an MT conditional configuration, for each candidate target cell indicated in the MT conditional configuration, such an indication may be provided. Additionally, it may be indicated an index to the F1 conditional reconfiguration to be applied for a certain cell.
vii. In one variant, the conditional F1 configuration comprises the information necessary for the mIAB-DU to set up F1 to the new donor. Some non-limiting examples of this information are the TNL/IP addresses of the new donor, such as the target donor radio access node Y (e.g., separate addresses for F1-C, F1-U and non-F1 traffic), configuration needed to set up SCTP connection to the new donor, the information/configuration for setting up the IPsec tunnel between the mIAB-DU and the new donor, GTP TEIDs of the GTP-U tunnels to be used for user plane traffic, list of cells to be served by the mIAB-DU under new donor together with gNB-DU system information for every cell, BAP address(es) of the mIAB node, etc.
viii. In one sub-variant, the configuration pertains only to F1-C traffic, i.e., only to the F1 connection setup, in another embodiment, the configuration pertains to both F1-C (i.e., F1 connection setup) and/or F1-U traffic and non-F1 traffic.
ix. NOTE: the “TNL/IP addresses of the new donor” in the configuration pertain IQ the taroet CU and the mIAB 550 may need them to initiate F1 setup to the new donor Y.

2. The mIAB 550 may be Instructed to apply one of the conditional F1 configurations. For example, the mIAB 550 may be instructed to apply the parameters of the conditional F1 configuration. The trigger for applying a particular configuration may be, e.g., that the mIAB-MT executes or completes a CHO to a target cell (i.e. send RRCReconigurationComplete), or the mIAB-MT receives an RRC message including a reconfiguration with sync for ordinary (non-CHO) handover to a target cell.
i. In one variant, the configuration is activated when (e.g., in parallel or after) the mIAB-MT executes a hand-over to the target parent. Alternatively, the F1 configuration is activated at HO completion, i.e., when the mIAB node 550 sends an RRCReconfigurationComplete message. The handover may be either an ordinary handover executed upon reception of RRC message with reconfiguration with synch, or upon fulfilling the MT conditional configuration conditions (e.g., fulfilling A3/A5 events). The Indication of which of the candidate F1 configurations is to be activated may be implicit or explicit.
   a) A non-limiting example of Implicit Indication is that mIAB-MT receives in the handover command or in the MT conditional configuration a target cell Identifier (as in legacy handover). In one method, the mIAB-MT may conclude from the target cell identifier the corresponding F1 configuration. This may be achieved by combining this method with the abovementioned method 1.ii, so that the IAB-MT part of the IAB node is provided for each target cell an indication of whether for that candidate target cell the IAB node should apply an F1 conditional reconfiguration). If the target cell is one of the cells for which F1 conditional reconfiguration should be applied, the mIAB-MT informs the mIAB-DU by indicating the cell to which the handover was executed/completed. The mIAB-DU applies then the corresponding F1 configuration for this cell. If the target cell is not one of the cells for which F1 conditional reconfiguration should be applied, the mIAB-MT may not signal anything to the mIAB-DU, so that the mIAB-DU keeps the current F1 configuration. Alternatively, it may signal to the mIAB-DU that, for this target cell, there is no F1 configuration. The mIAB-DU may release the current F1 configuration and request a new one to the CU or wait for the CU to provide a new F1 configuration.
   A variant of this method in which the mIAB-MT is provided with the gNB DU-ID of the parent access node 1, 2, 3, 4 hosting the target cell to which the mIAB node is being handed-over, and the gNB DU-ID is indicated by the mIAB-MT to the mIAB DU which in turn determines the F1 condition configuration to apply, based on the gNB-DU hosting the target cell.
   b) Another non-limiting example of Implicit Indication is that the mIAB-MT receives in the handover command or in the CHO configuration a target cell Identifier (as in legacy handover). When it executes or completes the handover, the mIAB-MT indicates to the mIAB-DU the cell identifier of the cell to which the handover was executed/completed. The mIAB-DU determines whether for the indicated cell, an F1 reconfiguration should be applied or not. For example, this method may be combined with the method 1.ii above according to which the mIAB-DU is provided with a target cell identifier or target gNB-DU ID associated to the target cell. If the mIAB-DU has a valid F1 configuration for the cell indicated by the mIAB-MT, and if such a valid F1 configuration is different from the configuration currently used by the mIAB node 550, the mIAB-DU applies such a new valid F1 configuration for the cell. Otherwise, if the valid configuration is already in use, the mIAB-DU keeps it. If, for the indicated cell, there is no valid configuration, the mIAB-DU may release the current F1 configuration and request a new one to the CU or wait for the CU to provide a new F1 configuration.
   c) A non-limiting example of explicit Indication may be a newly defined Identifier of the F1 configuration, which may be, e.g., delivered together or separately from the handover command for the mIAB-MT or included in the MT conditional configuration. For example, if for each target cell, the mIAB-MT is configured with an index to the F1 conditional configuration to be applied in case of handover to such target cell, the mIAB-MT indicates to the mIAB-DU such an index. The mIAB-DU then applies the F1 configuration associated to such an index. If for the target cell there is not provided an index, the mIAB-MT may refrain from signal anything to the mIAB-DU, so that the mIAB-DU keeps the current F1 configuration. Alternatively, it may signal to the mIAB-DU that for this target cell there is no index for an F1 configuration. The mIAB-DU may release the current F1 configuration and request a new one to the CU, or waits for the CU to provide a new F1 configuration.
   d) For both explicit and implicit indication cases, if the mIAB-MT receives the indication of which F1 configuration to activate, the mIAB-MT needs to indicate this to its IAB-DU.
ii. In another variant the F configuration is activated while the mIAB 550 is still connected to the old donor (NOTE: the second Fr connection is established by activating one of the conditional FA configurations).
iii. The mIAB-DU establishes an IPsec tunnel to the new donor, the SCTP connection to the new donor and the F1 connection to the new donor based on the indicated and selected conditional F1 configuration.

An example implementation of conditional Fw configuration delivery from the gNB-CU (donor) to the mIAB node 550 is shown in FIG. 9a. In other words, FIG. 9a also illustrates an example of a procedure for storing the conditional connection configuration, such as the conditional F1 configuration.

FIG. 9a also illustrates how the connection configuration, such as the F1 configuration, may be activated by transmitting an activation message from the in-IAB 550 to the gNB-CU (donor). For example, as mentioned above the configuration may be activated when (e.g., in parallel or after) the mIAB-MT executes a hand-over to the target parent AB node 1, 2, 3, 4.

An example implementation of storing of different conditional F1 configurations is shown in the table below.

TABLE
An example implementation of storing of different conditional F1 configurations

| | | | | | | List of cells |
|---|---|---|---|---|---|---|
| | | | | | | to be |
| | | | | | | served by |
| | | | | | | the mIAB- |
| | | | | | | DU under |
| | | | | | | new donor |
| | | | | | | together |
| | | | GTP TEID | | BAP | with gNB- |
| | | | GTP | TNL Address | address | DU system |
| | | | Tunnel | Transport | of the | information |
| | Target | CU IP | Endpoint | Layer | mIAB | for every |
| F1 Index | IAB cell | Address(es) | Identifier | Address | node | cell |
| 1 | Cell ID A | IP Address | OCTET | BIT STRING | BIT | List of cells |
| | | A | STRING | (SIZE(1 . . . 160) | STRING | and DU |
| | | | (SIZE(4)) | | (SIZE(10) | system |
| | | | | | | info |
| 2 | Cell ID B | IP Address | OCTET | BIT STRING | BIT | List of cells |
| | | B | STRING | (SIZE(1 . . . 160)) | STRING | and DU |
| | | | (SIZE(4)) | | (SIZE(10) | system |
| | | | | | | info |

An example ASN.1 is shown below where CU informs IAB-MT on F1 Configuration. The new parts are marked with bold.

RRCReconfiguration-v1610-IEs ::= SEQUENCE {

| | | |
|---|---|---|
| otherConfig-v1610 | OtherConfig-v1610 | OPTIONAL, -- Need M |
| bap-Config-r16 | SetupRelease { BAP-Config-r16 } | OPTIONAL, -- Need M |

| iab-IP-AddressConfigurationList-r16 IAB-IP-AddressConfigurationList-r16 | | OPTIONAL, -- Need M |
|---|---|---|
| conditionalReconfiguration-r16 | ConditionalReconfiguration-r16 | OPTIONAL, -- Need M |
| daps-SourceRelease-r16 | ENUMERATED{true} | OPTIONAL, -- Need N |
| t316-r16 | SetupRelease {T316-r16} | OPTIONAL, -- Need M |

| | |
|---|---|
| needForGapsConfigNR-r16 SetupRelease {NeedForGapsConfigNR-r16} | OPTIONAL, -- Need M |

onDemandSIB-Request-r16 SetupRelease { OnDemandSIB-Request-r16 }

OPTIONAL, -- Need M

```
  dedicatedPosSysInfoDelivery-r16 OCTET STRING (CONTAINING PosSystemInformation-r16-
IEs) OPTIONAL, -- Need N
  sl-ConfigDedicatedNR-r16 SetupRelease {SL-ConfigDedicatedNR-r16} OPTIONAL, -- Need M
```

| sl-ConfigDedicatedEUTRA-Info-r16 | SetupRelease {SL-ConfigDedicatedEUTRA-Info-r16} | |
|---|---|---|
| | | OPTIONAL, -- Need M |
| targetCellSMTC-SCG-r16 | SSB-MTC | OPTIONAL, -- Need S |
| nonCriticalExtension | RRCReconfiguration-v18xy-IEs OPTIONAL | |
| } | | |

| | |
|---|---|
| RRCReconfiguration-v18xy-IEs | ::= SEQUENCE { |
| conditionalF1ConfigurationList-r18 | ConditionalF1ConfigurationList-r18 |

OPTIONAL, -- Need M

```
  nonCriticalExtension
  SEQUENCE { }
```

}

ConditionalF1ConfigurationList-r18 ::= SEQUENCE (SIZE(1..maxF1Config)) OF

ConditionalF1Configuration-r18

ConditionalF1Configuration-r18 ::= SEQUENCE {

| iab-DU-CellIdentity-r18 | CellIdentity | OPTIONAL, |
|---|---|---|
| iab-IP-AddressConfigurationList-r18 | IAB-IP-AddressConfigurationList-r16 | OPTIONAL, |
| gtp-TunnelEndPoint-r18 | OCTET STRING (SIZE (4)) | OPTIONAL, |
| tnl-Address-r18 | BIT STRING (SIZE (160) ) | OPTIONAL |
| } | | |

### Confirmation of F1 Setup/Activation

FIG. 9b is a signaling diagram between the IAB donor CU and the mobile gNB-DU and illustrates an embodiment of confirmation of connection setup, such as Confirmation of F1 Setup, or in other words an activation of the connection setup, such as the F1 setup.

Once the F1 connection is successfully set up based upon the stored information, the mobile IAB-DU may inform the CU that the F1 connection has been set up by sending a message to the CU, such as the F1 CHO complete message in FIG. 6 (Step 4). The CU may also send an acknowledgement to the mobile IAB-DU.

Alternatively, the mIAB-MT may provide a confirmation of F1 setup in the CHO Complete (RRC Reconfig complete) message to the new donor Y.

Alternatively, once the mIAB-MT sends a CHO complete message, e.g., included in RRC Reconfig complete, illustrated in FIG. 6 (Step 3), the CU may send a newly defined F1 SETUP QUERY message to the mIAB-DU and the response F1 SETUP QUERY ACKNOWLEDGE is then provided by mIAB-DU.

In case F1 setup based upon stored information fails, IAB CU may then initiate bootstrapping for the mIAB node procedure (as described in background section, i.e., the mIAB node is reset and it joins the network as a new node that just powered up).

### APPENDIX

### Conditional Handover

Conditional handover (CHO) is a release 16 solution that improves robustness of mobility of different UEs. This is especially useful for services that require low-latency and highly reliable coverage and performance. CHO focuses on reducing the number of connection failures due to user mobility.

Compared to regular handover where only a single cell is prepared for handover, in CHO, multiple candidate target cells are prepared in advance, even before the UE requires handover due to degraded radio connection. The UE only applies the stored command when a condition configured in the configuration is satisfied and then it executes a handover and connects to a target node like a normal handover.

The network prepares one or more target cells due to absence of certainty on which cell the UE will access next. The CHO command sent to the target cells is similar to the legacy handover and a “RRCReconfigurationmessage” is created with the target configuration that is then sent to the UE. The UE however does not apply the configuration right away and stores it. In some cases the UE may not even apply this configuration.

The CHO configuration is delivered to the UE via RRC signalling while the UE is connected to a certain cell. The CHO configuration provided by the gNB implies a RRCReconfiguration message containing a reconfiguration with sync (reconigurationWithSync) for each candidate cell towards which the UE may perform the conditional handover. Upon reception of such CHO configuration, the UE stores it until either it is applied or released, e.g. due to handover, or radio link failure. Additionally, such RRCReconfiguration message indicates for each candidate cell one or more measurement events. When such measurement events are fulfilled for a certain candidate cell, the UE executes the handover, e.g., applies the reconfiguration with sync associated with the corresponding cell that was previously stored.

HANDOVER REQUEST message and its ACKNOWLEDGE message from 3gpp TS 38.423 are given below. The conditional handover IEs are underlined and marked in bold for convenience.

### 9.1.1.1 Handover Request

This message is sent by the source NG-RAN node to the target NG-RAN node to request the preparation of resources for a handover.

### Direction: Source NG-RAN Node to Target NG-RAN Node.

| IE/Group | | | IE type and | | | Assigned |
|---|---|---|---|---|---|---|
| Name | Presence | Range | reference | Semantics description | Criticality | Criticality |
| Message | M | | 9.2.3.1 | | YES | reject |
| Type | | | | | | |
| Source NG- | M | | NG-RAN | Allocated at the source | YES | reject |
| RAN node | | | node UE | NG-RAN node | | |
| UE XnAP ID | | | XnAP ID | | | |
| reference | | | 9.2.3.16 | | | |
| Cause | M | | 9.2.3.2 | | YES | reject |
| Target Cell | M | | 9.2.3.25 | Includes either an E-UTRA | YES | reject |
| Global ID | | | | CGI or an NR CGI | | |
| GUAMI | M | | 9.2.3.24 | | YES | reject |
| UE Context | | 1 | | | YES | reject |
| Information | | | | | | |
| >NG-C UE | M | | AMF UE | Allocated at the AMF on | — | |
| associated | | | NGAP ID | the source NG-C | | |
| Signalling | | | 9.2.3.26 | connection. | | |
| reference | | | | | | |
| >Signalling | M | | CP | This IE indicates the AMF's | — | |
| TNL | | | Transport | IP address of the SCTP | | |
| association | | | Layer | association used at the | | |
| address at | | | Information | source NG-C interface | | |
| source NG- | | | 9.2.3.31 | instance. | | |
| C side | | | | Note: | | |
| | | | | If no UE TNLA | | |
| | | | | binding exists at the source | | |
| | | | | NG-RAN node, the source | | |
| | | | | NG-RAN node indicates | | |
| | | | | the TNL association | | |
| | | | | address it would have | | |
| | | | | selected if it would have | | |
| | | | | had to create a UE TNLA | | |
| | | | | binding. | | |
| >UE | M | 9.2.3.49 | | | — | |
| Security | | | | | | |
| Capabilities | | | | | | |
| >AS | M | 9.2.3.50 | | | — | |
| Security | | | | | | |
| Information | | | | | | |
| >Index to | O | 9.2.3.23 | | | — | |
| RAT/ | | | | | | |
| Frequency | | | | | | |
| Selection | | | | | | |
| Priority | | | | | | |
| >UE | M | 9.2.3.17 | | | — | |
| Aggregate | | | | | | |
| Maximum | | | | | | |
| Bit Rate | | | | | | |
| >PDU | | 1 | 9.2.1.1 | Similar to NG-C signalling, | — | |
| Session | | | | containing UL tunnel | | |
| Resources | | | | information per PDU | | |
| To Be Setup | | | | Session Resource; | | |
| List | | | | and in addition, the source | | |
| | | | | side QoS flow □□DRB | | |
| | | | | mapping | | |
| >RRC | M | | OCTET | Either includes the | — | |
| Context | | | STRING | HandoverPreparationInformation | | |
| | | | | message as | | |
| | | | | defined in subclause | | |
| | | | | 10.2.2. of TS 36.331 [14], | | |
| | | | | or the | | |
| | | | | HandoverPreparationInformation- | | |
| | | | | NB message as | | |
| | | | | defined in subclause | | |
| | | | | 10.6.2 of TS 36.331 [14], if | | |
| | | | | the target NG-RAN node is | | |
| | | | | an ng-eNB, | | |
| | | | | or the | | |
| | | | | HandoverPreparationInformation | | |
| | | | | message as | | |
| | | | | defined in subclause | | |
| | | | | 11.2.2 of TS 38.331 [10], if | | |
| | | | | the target NG-RAN node is | | |
| | | | | a gNB. | | |
| >Location | O | | 9.2.3.47 | Includes the necessary | — | |
| Reporting | | | | parameters for location | | |
| Information | | | | reporting. | | |
| >Mobility | O | | 9.2.3.53 | | — | |
| Restriction | | | | | | |
| List | | | | | | |
| >Management | O | | MDT PLMN | | YES | ignore |
| Based | | | List | | | |
| MDT PLMN | | | 9.2.3.133 | | | |
| List | | | | | | |
| >5GC | O | | 9.2.3.100 | | YES | ignore |
| Mobility | | | | | | |
| Restriction | | | | | | |
| List | | | | | | |
| Container | | | | | | |
| >NR UE | O | | 9.2.3.107 | This IE applies only if the | YES | ignore |
| Sidelink | | | | UE is authorized for NR | | |
| Aggregate | | | | V2X services. | | |
| Maximum | | | | | | |
| Bit Rate | | | | | | |
| >LTE UE | O | | 9.2.3.108 | This IE applies only if the | YES | ignore |
| Sidelink | | | | UE is authorized for LTE | | |
| Aggregate | | | | V2X services. | | |
| Maximum | | | | | | |
| Bit Rate | | | | | | |
| >UE Radio | O | | 9.2.3.138 | | YES | reject |
| Capability ID | | | | | | |
| Trace | O | | 9.2.3.55 | | YES | ignore |
| Activation | | | | | | |
| Masked | O | | 9.2.3.32 | | YES | ignore |
| IMEISV | | | | | | |
| UE History | M | | 9.2.3.64 | | YES | ignore |
| Information | | | | | | |
| UE Context | O | | | | YES | ignore |
| Reference | | | | | | |
| at the S- | | | | | | |
| NG-RAN | | | | | | |
| node | | | | | | |
| >Global NG- | M | | 9.2.2.3 | | — | |
| RAN Node | | | | | | |
| ID | | | | | | |
| >S-NG-RAN | M | | NG-RAN | | — | |
| node UE | | | node UE | | | |
| XnAP ID | | | XnAP ID | | | |
| | | | 9.2.3.16 | | | |
| Conditional | O | | | | YES | reject |
| Handover | | | | | | |
| Information | | | | | | |
| Request | | | | | | |
| >CHO | M | | ENUMERATED | | — | |
| Trigger | | | (CHO- | | | |
| | | | initiation, | | | |
| | | | CHO- | | | |
| | | | replace, . . . ) | | | |
| >Target | C- | | NG-RAN | Allocated at the target NG- | — | |
| NG-RAN | ifCHOmod | | node UE | RAN node | | |
| node UE | | | XnAP ID | | | |
| XnAP ID | | | 9.2.3.16 | | | |
| >Estimated | O | | INTEGER | | — | |
| Arrival | | | (1 . . . 100) | | | |
| Probability | | | | | | |
| NR V2X | O | | 9.2.3.105 | | YES | ignore |
| Services | | | | | | |
| Authorized | | | | | | |
| LTE V2X | O | | 9.2.3.106 | | YES | ignore |
| Services | | | | | | |
| Authorized | | | | | | |
| PC5 QoS | O | | 9.2.3.109 | This IE applies only if the | YES | ignore |
| Parameters | | | | UE is authorized for NR | | |
| | | | | V2X services. | | |
| Mobility | O | | BIT STRING | Information related to the | YES | ignore |
| Information | | | (SIZE (32)) | handover; the source NG- | | |
| | | | | RAN node provides it in | | |
| | | | | order to enable later | | |
| | | | | analysis of the conditions | | |
| | | | | that led to a wrong HO. | | |
| UE History | O | | 9.2.3.110 | | YES | ignore |
| Information | | | | | | |
| from the UE | | | | | | |
| IAB Node | O | | ENUMERATED | | YES | reject |
| Indication | | | (true, . . . ) | | | |

| Condition | Explanation |
|---|---|
| ifCHOmod | This IE shall be present if the CHO Trigger IE is |
| | present and set to “CHO-replace”. |

| Range bound | Explanation |
|---|---|
| maxnoofMDTPLMNs | PLMNs in the Management Based MDT PLMN |
| | list. Value is 16. |

### 9.1.1.2 Handover Request Acknowledge

This message is sent by the target NG-RAN node to inform the source NG-RAN node about the prepared resources at the target.

### Direction: Target NG-RAN Node to Source NG-RAN Node.

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | | | |
|---|---|---|---|---|---|
| Message Type | M | 9.2.3.1 | | YES | reject |
| Source NG- | M | NG-RAN | Allocated at the | YES | ignore |
| RAN node UE | | node UE | source NG-RAN | | |
| XnAP ID | | XnAP ID | node | | |
| | | 9.2.3.16 | | | |
| Target NG- | M | NG-RAN | Allocated at the | YES | ignore |
| RAN node UE | | node UE | target NG-RAN node | | |
| XnAP ID | | XnAP ID | | | |
| | | 9.2.3.16 | | | |
| PDU Session | M | 9.2.1.2 | | YES | ignore |
| Resources | | | | | |
| Admitted List | | | | | |
| PDU Session | O | 9.2.1.3 | | YES | ignore |
| Resources Not | | | | | |
| Admitted List | | | | | |
| Target NG- | M | OCTET | Either includes the | YES | ignore |
| RAN node To | | STRING | HandoverCommand | | |
| Source NG- | | | message as defined | | |
| RAN node | | | in subclause 10.2.2 | | |
| Transparent | | | of TS 36.331 [14], if | | |
| Container | | | the target NG-RAN | | |
| | | | node is an ng-eNB, | | |
| | | | or the | | |
| | | | HandoverCommand | | |
| | | | message as defined | | |
| | | | in subclause 11.2.2 | | |
| | | | of TS 38.331 [10], if | | |
| | | | the target NG-RAN | | |
| | | | node is a gNB. | | |
| UE Context | O | 9.2.3.68 | | YES | ignore |
| Kept Indicator | | | | | |
| Criticality | O | 9.2.3.3 | | YES | ignore |
| Diagnostics | | | | | |
| DRBs | O | DRB List | In case of DC, | YES | ignore |
| transferred to | | 9.2.1.29 | indicates that SN | | |
| MN | | | Status is needed for | | |
| | | | the listed DRBs from | | |
| | | | the S-NG-RAN node. | | |
| DAPS | O | 9.2.1.34 | | YES | reject |
| Response | | | | | |
| Information | | | | | |
| Conditional | O | | | YES | reject |
| Handover | | | | | |
| Information | | | | | |
| Acknowledge | | | | | |
| >Requested | M | Target | Target cell indicated | — | |
| Target Cell ID | | Cell | in the corresponding | | |
| | | Global ID | HANDOVER | | |
| | | 9.2.3.25 | REQUEST message | | |
| >Maximum | O | 9.2.3.101 | | — | |
| Number of | | | | | |
| CHO | | | | | |
| Preparations | | | | | |

Embodiments herein enable a reduction in F1 connection setup time. No need to rely upon a slow bootstrapping procedure.

Embodiments herein enable a reduced delay, no (little) interruption, better QoS experience for the UE, less handover failure probability.

Embodiments herein enable a reduction of service interruption and avoidance of a signaling storm that may otherwise be caused by reconfiguration on a short notice. Reduction of the probability of handover failure.

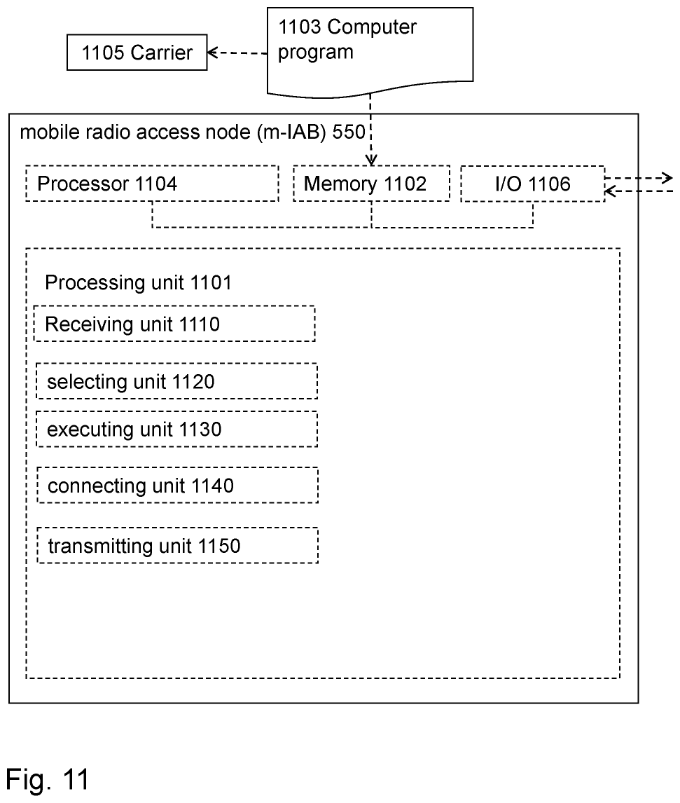

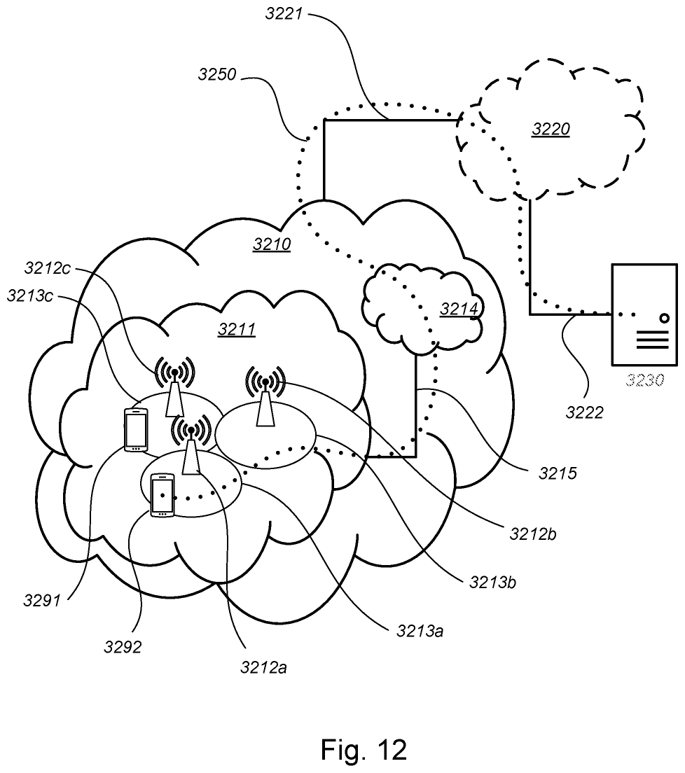

FIG. 10 shows an example of a donor radio access node (gNB-CU) 1000 and FIG. 11 shows an example of the mobile radio access node (m-IAB) 550. The donor radio access node (gNB-CU) 1000 corresponds to any of the donor radio access nodes X, Y above. The donor radio access node 1000 may be configured to perform the method actions of FIG. 7 above. The mobile radio access node 550 may be configured to perform the method actions of FIG. 8 above. The units of the donor radio access node 1000 described below may be implemented in the CU of the donor radio access node 1000. The units of the mobile radio access node 550 described below may be implemented in the MT or the DU of the mobile radio access node 550.

As mentioned above, the donor radio access node 1000 is configured for assisting in inter-donor-CU handovers and setting up the connection F1-Y between the mobile radio access node 550 and the target serving donor radio access node Y in the wireless communications network 500.

In some embodiments wherein the radio access nodes 550, 1000 of the wireless communications network 500 apply the CU-DU split, the connection F1-Y between the mobile radio access node 550 and the target serving donor radio access node Y is the connection between the DU of the mobile radio access node 550 and the CU of the target donor radio access node Y. Then the CU of the donor radio access node 1000 may be configured to perform the method of FIG. 7.

The donor node 1000 and mobile radio access node 550 may each comprise a respective input and output Interface, IF, 1006, 1106 configured to communicate, e.g., with each other, see FIGS. 10-11. The input and output interface may comprise a receiver (not shown) and a transmitter (not shown). Both the respective receiver and the respective transmitter may be wireless.

The donor node 1000 and mobile radio access node 550 may each comprise a respective processing unit 1001, 1101 for performing the above method actions. The respective processing unit 1001, 1101 may comprise further sub-units which will be described below.

The donor node 1000 and mobile radio access node 550 may further comprise a respective a receiving unit 1020, 1110, and a transmitting unit 1010, 1150, see FIGS. 10 and 11 which may receive and transmit messages and/or signals.

The donor radio access node 1000 is further configured to, e.g., by the transmitting unit 1010 being configured to, transmit one or more conditional configurations for the connection F1 to the mobile radio access node 550, the respective conditional configuration of the one or more conditional configurations may comprises the conditional configuration command which is to be applied when the condition for applying the conditional configuration command is satisfied.

The donor radio access node 1000 may be configured to transmit the one or more conditional configurations to the mobile radio access node 550 via the RRC signaling or via the signaling on the connection F1-X between the mobile radio access node 550 and the source serving donor radio access node X, respectively.

In some embodiments the donor radio access node is configured to transmit the one or more conditional configurations to the mobile radio access node 550 via the RRC signaling in the RRCReconfiguration message.

The donor radio access node 1000 further configured to, e.g., by the receiving unit 1020 being configured to, receive the configuration activation for the connection F1-Y between the mobile radio access node 550 and the target serving donor radio access node Y from the mobile radio access node 550 in response to the transmitted one or more conditional configurations.

The mobile radio access node 550 may further comprise a selecting unit 1120 which for example may select the new F1 connection.

The donor node 1000 and the mobile radio access node 550 may further comprise an executing unit 1030, 1130 which for example may execute a handover.

The donor node 1000 and the mobile radio access node 550 may further comprise a connecting unit 1040, 1140 which for example may establish the new F1 connection.

As mentioned above, the mobile radio access node 550 is configured for inter-donor-CU handovers and setting up the connection F1-Y between the mobile radio access node 550 and the target serving donor radio access node Y in the wireless communications network 500.

The mobile radio access node 550 is further configured to, e.g., by the receiving unit 1110 being configured to, receive, from the donor radio access node 1000, the one or more conditional configurations for the connection F1-Y between the mobile radio access node 550 and the target serving donor radio access node Y. The respective conditional configuration of the one or more conditional configurations comprises the conditional configuration command which is to be applied when the condition for applying the conditional configuration command is satisfied.

The mobile radio access node 550 may be configured to receive the one or more conditional configurations via RRC signaling in an RRCReconfiguration message.

In some embodiments the mobile radio access node 550 comprises the central unit configured to receive the one or more conditional configurations for the connection F1-Y between the mobile radio access node 550 and the target serving donor radio access node Y via RRC. In some other embodiments the mobile radio access node 550 comprises the distributed unit mIAB-DU configured to receive the one or more conditional configurations for the connection F1-Y between the mobile radio access node 550 and the target serving donor radio access node Y via the connection F1-X between the mobile radio access node 550 and the source serving donor radio access node X. The mobile radio access node 550 may comprise both a CU and a DU. Both the CU and the DU of the mobile radio access node 550 may comprise the receiving unit 1110.

The mobile radio access node 550 is further configured to, e.g., by the selecting unit 1120 being configured to, select the conditional configuration of the one or more conditional configurations based on satisfaction of the condition for applying the selected conditional configuration.

In some embodiments herein the mobile radio access node 550 is further configured to, e.g., by the selecting unit 1120 being configured to, select the new parent access node 1, 2, 3, 4, and select the conditional configuration of the one or more conditional configurations is based on the selected new parent access node 1, 2, 3, 4.

The mobile radio access node 550 is further configured to, e.g., by the connecting unit 1140 being configured to, establish the connection F1-Y to the target serving donor radio access node Y based on the selected conditional configuration.

The mobile radio access node 550 may further be configured to, e.g., by the connecting unit 1140 being configured to, establish any one or more of: the secure IP tunnel to the target donor, and the SCTP connection to the target donor based on the selected conditional configuration.

The mobile radio access node 550 may further be configured to, e.g., by the transmitting unit 1150 being configured to, transmit the configuration activation for the connection F1-Y between the mobile radio access node 550 and the target serving donor radio access node Y from the mobile radio access node 550 in response to the received one or more conditional configurations.

The embodiments herein may be implemented through a respective processor or one or more processors, such as the respective processor 1004, and 1104, of a processing circuitry in the donor node and mobile radio access node 550, and depicted in FIGS. 10-11 together with computer program code for performing the functions and actions of the embodiments herein. The program code mentioned above may also be provided as a computer program product, for instance in the form of a data carrier carrying computer program code for performing the embodiments herein when being loaded into the respective donor node and mobile radio access node 550. One such carrier may be in the form of a CD ROM disc. It is however feasible with other data carriers such as a memory stick. The computer program code may furthermore be provided as pure program code on a server and downloaded to the respective donor node and mobile radio access node 550.

The donor node and mobile radio access node 550 may further comprise a respective memory 1002, and 1102 comprising one or more memory units. The memory comprises instructions executable by the processor 1004, 1104 in the donor node X, Y and the mobile radio access node 550.

Each respective memory 1002 and 1102 is arranged to be used to store e.g. information, data, configurations, and applications to perform the methods herein when being executed in the respective donor node X, Y and the mobile radio access node 550.

In some embodiments, a respective computer program 1003 and 1103 comprises instructions, which when executed by the processor 1004, 1104, cause the processor 1004, 1104 of the respective donor node X, Y and mobile radio access node 550 to perform the actions above.

In other words, the computer program 1003 may comprise computer readable code units which when executed on the donor radio access node 1000 causes the donor radio access node 1000 to perform the method according to FIG. 7. Correspondingly, the computer program 1103 may comprise computer readable code units which when executed on the mobile radio access node 550 causes the mobile radio access node 550 to perform the method according to FIG. 8.

In some embodiments, a respective carrier 1005 and 1105 comprises the respective computer program 1003, 1103, wherein the carrier 1005, 1105 is one of an electronic signal, an optical signal, an electromagnetic signal, a magnetic signal, an electric signal, a radio signal, a microwave signal, or a computer-readable storage medium.

Those skilled in the art will also appreciate that the units described above may refer to a combination of analog and digital circuits, and/or one or more processors configured with software and/or firmware, e.g. stored in the respective donor node and mobile radio access node 550, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

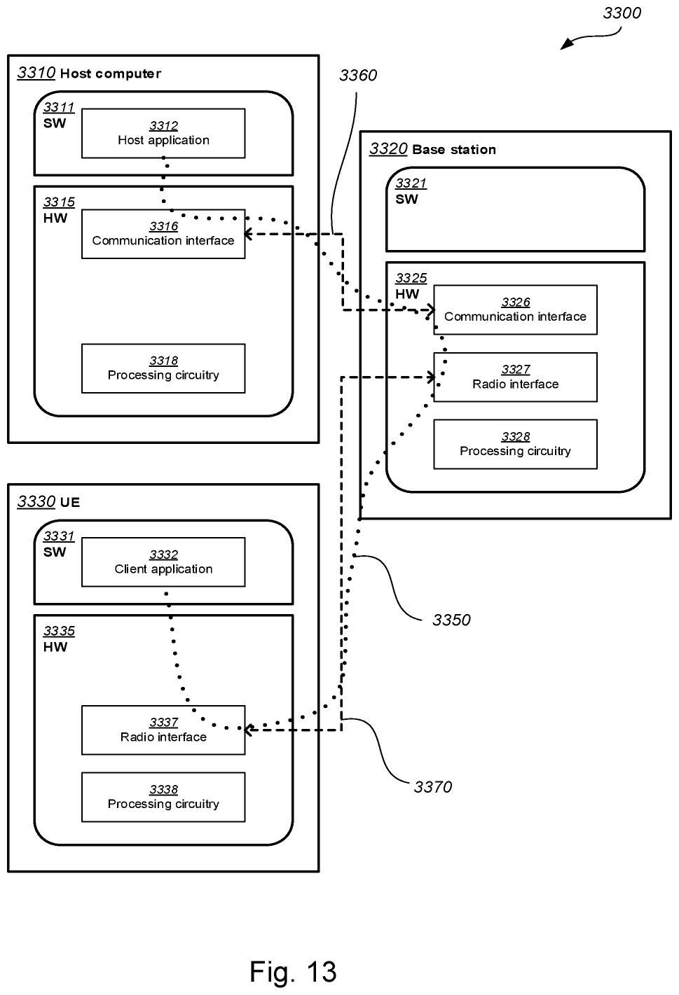

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 such as e.g. the UE 121, and the host computer 3230.

The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

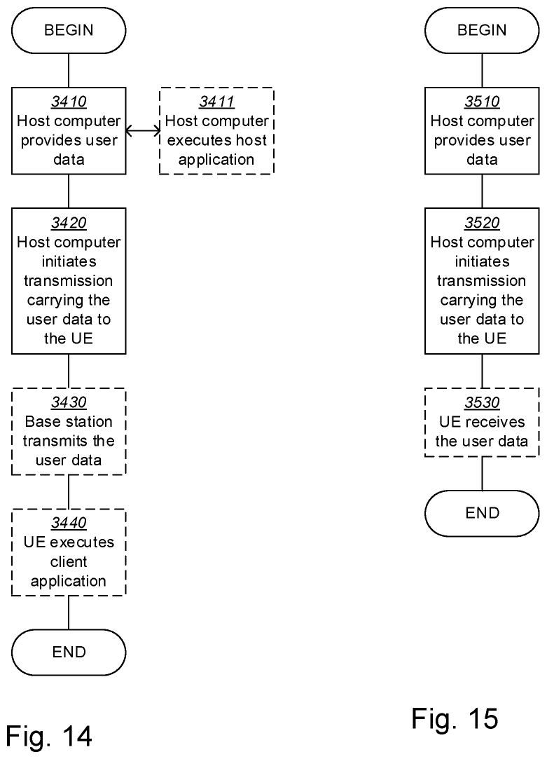

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

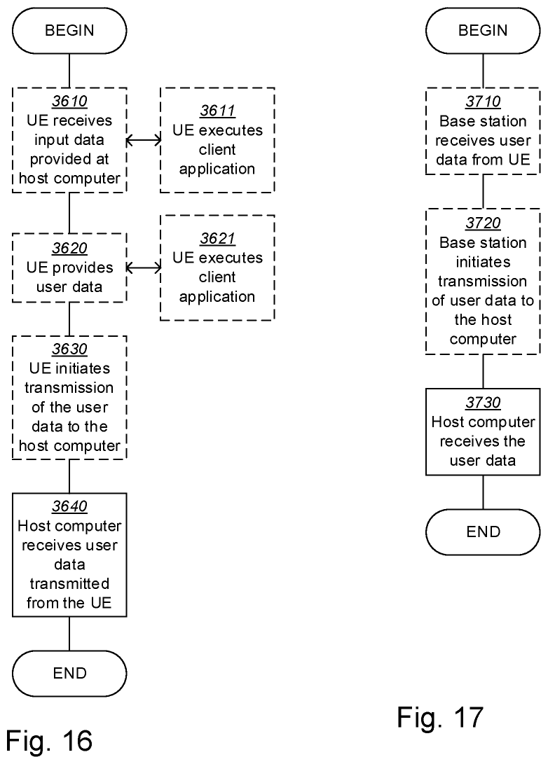

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 12 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 15 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

| Abbreviation | Explanation |
|---|---|
| IAB | Integrated access and backhaul |
| HO | Handover |
| CHO | Conditional Handover |
| CU | Centralized Unit |
| DU | Distributed Unit |

1.-35. (canceled)

36. A method, performed by a donor radio access node, for assisting in inter-donor-CU handovers and for setting up a connection between a mobile radio access node and a target serving donor radio access node in a wireless communications network, the method comprises:
transmitting one or more conditional configurations for the connection to the mobile radio access node, wherein the one or more conditional configurations include respective conditional configuration commands for the connection, wherein each conditional configuration command is to be applied when a corresponding condition for application is satisfied.

37. The method according to claim 36, wherein:
each conditional configuration for the connection comprises information necessary for the mobile radio access node to set up the connection to the target serving donor radio access node; and
the information necessary for the mobile radio access node to set up the connection to the target serving donor radio access node comprises one or more of the following:
at least one of the following addresses of the target serving donor radio access node: Transport Network Layer (TNL), and Internet Protocol (IP);
configuration needed to set up a Stream Control Transmission Protocol (SCTP) connection to the target serving donor radio access node;
configuration for setting up a secure IP tunnel between the mobile radio access node and the target serving donor radio access node;
a list of cells to be served by a distributed unit of the mobile radio access node under the target serving donor radio access node together with system information for every cell comprised in the list of cells, the system information is owned by the distributed unit of the mobile radio access node; and
one or more Backhaul Adaptation Protocol (BAP) addresses of the mobile radio access node.

38. The method according to claim 36, wherein the one or more conditional configurations are transmitted to the mobile radio access node via signaling on a second connection between the mobile radio access node and a source serving donor radio access node.

39. The method according to claim 36, wherein:
the one or more conditional configurations are transmitted to the mobile radio access node via radio resource control (RRC) signaling in a conditional reconfiguration information element (IE) of an RRCReconfiguration message; and
the conditional reconfiguration IE comprises a conditional reconfiguration list for the connection between the mobile radio access node and the target serving donor radio access node, wherein the list includes configurations of the connection for respective candidate target parent access nodes.

40. The method according to claim 36, wherein the donor radio access node is a donor Integrated Access and Backhaul (IAB) node and the mobile radio access node is a mobile IAB node.

41. The method according to claim 36, wherein the method is performed by a central unit (CU) of the donor radio access node, and the connection is between a distributed unit (DU) of the mobile radio access node and a CU of the target serving donor radio access node.

42. The method according to claim 41, wherein:
the wireless communications network (500) is a New Radio (NR) network;
the mobile radio access node is a mobile Integrated Access and Backhaul (IAB) node;
the target serving donor radio access node is an IAB-donor gNB; and
the connection between the mobile radio access node and the target serving donor radio access node is an F1 connection between the DU of the mobile IAB node and the CU of the IAB-donor gNB.

43. The method according to claim 36, wherein the method is performed by one of the following: the target serving donor radio access node, or the source serving donor radio access node.

44. The method according to claim 36, further comprising, in response to transmitting the one or more conditional configurations, receiving from the mobile radio access node a configuration activation for the connection between the mobile radio access node and the target serving donor radio access node.

45. A method, performed by a mobile radio access node, for inter-donor-CU handovers and setting up a connection between the mobile radio access node and a target serving donor radio access node in a wireless communications network, the method comprising:
receiving, from a donor radio access node, one or more conditional configurations for the connection between the mobile radio access node and the target serving donor radio access node, wherein the one or more conditional configurations include respective conditional configuration commands for the connection, wherein each conditional configuration command is to be applied when a corresponding condition for application is satisfied;
selecting one of the conditional configurations whose corresponding condition for application is satisfied; and
establishing the connection to the target serving donor radio access node based on the selected conditional configuration.

46. The method according to claim 45, wherein:
the one or more conditional configurations are received via radio resource control (RRC) signaling in a conditional reconfiguration information element (IE) of an RRCReconfiguration message; and
the conditional reconfiguration IE comprises a conditional reconfiguration list for the connection between the mobile radio access node and the target serving donor radio access node, wherein the list includes configurations of the connection for respective candidate target parent access nodes.

47. The method according to claim 45, further comprising selecting a new parent access node, wherein selecting one of the conditional configurations is further based on the selected new parent access node.

48. The method according to claim 45, further comprising, in response to receiving the one or more conditional configurations, transmitting to the donor radio access node a configuration activation for the connection between the mobile radio access node and the target serving donor radio access node.

49. The method according to claim 48, further comprising storing the received one or more conditional configurations in the mobile radio access node, wherein the stored selected conditional configuration is activated based on transmitting the configuration activation to the donor radio access node.

50. The method according to claim 45, further comprising establishing one or more of the following to the target serving donor radio access node, based on the selected conditional configuration: a secure Internet Protocol (IP) tunnel, and a Stream Control Transmission Protocol (SCTP) connection.

51. The method according to claim 45, wherein one of the following applies:
the one or more conditional configurations are received by a Central Unit (CU) of the mobile radio access node via radio resource control (RRC) signaling; or
the one or more conditional configurations are received by a distributed unit (DU) of the mobile radio access node via a second connection between the mobile radio access node and a source serving donor radio access node.

52. A donor radio access node configured for assisting in inter-donor-CU handovers and for setting up a connection between a mobile radio access node and a target serving donor radio access node in a wireless communications network, wherein the donor radio access node comprises:
one or more processors; and
memory storing computer program code executable by the one or more processors, wherein execution of the computer program code configures the donor radio access node to perform the method of claim 36.

53. A mobile radio access node configured for inter-donor-CU handovers and for setting up a connection between the mobile radio access node and a target serving donor radio access node in a wireless communications network, wherein the mobile radio access node comprises:
one or more processors; and
memory storing computer program code executable by the one or more processors, wherein execution of the computer program code configures the mobile radio access node to:
receive, from a donor radio access node, one or more conditional configurations for the connection between the mobile radio access node and the target serving donor radio access node, wherein the one or more conditional configurations include respective conditional configuration commands for the connection, wherein each conditional configuration command is to be applied when a corresponding condition for application is satisfied;
select one of the conditional configurations whose corresponding condition for application is satisfied; and
establish the connection to the target serving donor radio access node based on the selected conditional configuration.

54. The mobile radio access node according to claim 53, wherein:
the one or more conditional configurations are received via radio resource control (RRC) signaling in a conditional reconfiguration information element (IE) of an RRCReconfiguration message; and
the conditional reconfiguration IE comprises a conditional reconfiguration list for the connection between the mobile radio access node and the target serving donor radio access node, wherein the list includes configurations of the connection for respective candidate target parent access nodes.

55. The mobile radio access node according to claim 53, wherein execution of the computer program code further configures the mobile radio access node to select a new parent access node, and to select one of the conditional configurations further based on the selected new parent access node.

56. The mobile radio access node according to claim 53, wherein execution of the computer program code further configures the mobile radio access node to, in response to receiving the one or more conditional configurations, transmit to the donor radio access node a configuration activation for the connection between the mobile radio access node and the target serving donor radio access node.

57. The mobile radio access node according to claim 56, wherein execution of the computer program code further configures the mobile radio access node to store the received one or more conditional configurations in the mobile radio access node, and to activate the stored selected conditional configuration based on transmitting the configuration activation to the donor radio access node.

58. The mobile radio access node according to claim 53, wherein execution of the computer program code further configures the mobile radio access node to establish one or more of the following to the target serving donor radio access node, based on the selected conditional configuration: a secure Internet Protocol (IP) tunnel, and a Stream Control Transmission Protocol (SCTP) connection.

59. The mobile radio access node according to claim 53, wherein one of the following applies:
the one or more conditional configurations are received by a Central Unit (CU) of the mobile radio access node via radio resource control (RRC) signaling; or
the one or more conditional configurations are received by a distributed unit (DU) of the mobile radio access node via a second connection between the mobile radio access node and a source serving donor radio access node.
